(19) United States
(12) Patent Application Publication
(10) Pub. No.: US 2026/0039422 A1
(43) Pub. Date: Feb. 5, 2026

(54) UE-Assisted Multi-TRP operation

(71) Applicant: Fraunhofer-Gesellschaft zur Förderung der angewandten Forschung e.V., München (DE)

(72) Inventors: Paul Simon Holt LEATHER, Berlin-Schlachtensee (DE); Thomas HAUSTEIN, Berlin (DE); Lars THIELE, Berlin (DE)

(21) Appl. No.: 19/350,249

(22) Filed: Oct. 6, 2025

Related U.S. Application Data
(63) Continuation of application No. PCT/EP2024/059378, filed on Apr. 5, 2024.

(30) Foreign Application Priority Data
Apr. 6, 2023 (EP) 23166998.7
Aug. 10, 2023 (EP) 23190890.6

(51) Int. Cl. H04L 5/00; H04B 7/0413; H04W 24/10

(52) U.S. Cl. CPC H04L 5/0005; H04B 7/0413; H04W 24/10

(57) ABSTRACT

A user equipment, UE, is configured for operating in a wireless communication network that utilizes resources of a time/frequency grid. The UE is adapted to report to the wireless communication network a connectivity information associated to a first connectivity option of the UE to the wireless communication network and associated to a second connectivity option of the UE to the wireless communication network; and/or is adapted to receive, during a same instance of time, and decode a first signal received from a first transmission/reception point, TRP, and a second signal received from a second TRP, the first signal and the second signal occupying resources in the same time/frequency grid.

### CROSS-REFERENCES TO RELATED APPLICATIONS

This application is a continuation of copending International Application No. PCT/EP2024/059378, filed Apr. 5, 2024, which is incorporated herein by reference in its entirety, and additionally claims priority from European Applications Nos. EP 23166998.7, filed Apr. 6, 2023, and EP 23190890.6, filed Aug. 10, 2023, all of which are incorporated herein by reference in its entirety.

Embodiments of the present application relate to the field of wireless communication, and more specifically, to providing signals to a device by use of one or more transmission reception point, TRPs. Some embodiments relate to evaluating signals provided by a non-serving TRP.

### BACKGROUND OF THE INVENTION

FIG. 1 is a schematic representation of an example of a terrestrial wireless network 100 including, as is shown in FIG. 1(a), a core network 102 and one or more radio access networks RAN₁, RAN₂, . . . RAN_{N}. FIG. 1(b) is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The term base station (also base station), BS, refers to a gNB in 5G networks, an eNB in UMTS/LTE/LTE-A/LTE-A Pro, or just a BS in other mobile communication standards. A user may be a stationary device or a mobile device.

The network 100 may comprise one or more transmission reception points, TRPs. A TRP may but is not required to form an individual node of the network. For example, a base station may comprise one or a plurality of TRPs. For example, different TRPs of a base station may serve UEs in different areas or sectors of a cell operated by the base station, just to name a specific example.

The wireless communication system may also be accessed by mobile or stationary IoT devices which connect to a base station or to a user. The mobile devices or the IoT devices may include physical devices, ground-based vehicles, such as robots or cars, aerial vehicles, such as manned or unmanned aerial vehicles (UAVs), the latter also referred to as drones, buildings and other items or devices having embedded therein electronics, software, sensors, actuators, or the like as well as network connectivity that enables these devices to collect and exchange data across an existing network infrastructure. FIG. 1(b) shows an example of five cells, however, the RANₙ may include more or fewer such cells, and RANₙ may also include only one base station. FIG. 1(b) shows two users UE₁ and UE₂, also referred to as user equipment, UE, that are in cell 106₂ and that are served by base station gNB2. Another user UE₃ is shown in cell 106₄ which is served by base station gNB4. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. Further, FIG. 1(b) shows two IoT devices 110₁ and 110₂ in cell 106₄, which may be stationary or mobile devices. The IoT device 110₁ accesses the wireless communication system via the base station gNB4 to receive and transmit data as schematically represented by arrow 112₁. The IoT device 110₂ accesses the wireless communication system via the user UEs as is schematically represented by arrow 112₂. The respective base station gNB₁ to gNB₅ may be connected to the core network 102, e.g., via the S1 interface, via respective backhaul links 114₁ to 114₅, which are schematically represented in FIG. 1(b) by the arrows pointing to “core”. The core network 102 may be connected to one or more external networks. Furthermore, some or all of the respective base stations gNB₁ to gNB₅ may connected, e.g., via the S1 or X2 interface or the XN interface in NR, with each other via respective backhaul links 116₁ to 116₅, which are schematically represented in FIG. 1(b) by the arrows pointing to “gNBs”.

For data transmission a physical resource grid may be used. The physical resource grid may comprise a set of resource elements to which various physical channels and physical signals are mapped. For example, the physical channels may include the physical downlink, uplink and sidelink shared channels (PDSCH, PUSCH, PSSCH) carrying user specific data, also referred to as downlink, uplink and sidelink payload data, the physical broadcast channel (PBCH) carrying for example a master information block (MIB), the physical downlink shared channel (PDSCH) carrying for example a system information block (SIB), the physical downlink, uplink and sidelink control channels (PDCCH, PUCCH, PSSCH) carrying for example the downlink control information (DCI), the uplink control information (UCI) and the sidelink control information (SCI), respectively. For the uplink, the physical channels, or more precisely the transport channels according to 3GPP, may further include the physical random access channel (PRACH or RACH) used by UEs for accessing the network once a UE is synchronized and has obtained the MIB and SIB. The physical signals may comprise reference signals or symbols (RS), synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix (CP) length. All OFDM symbols may be used for DL or UL or only a subset, e.g., when utilizing shortened transmission time intervals (sTTIs) or a mini-slot/non-slot-based frame structure comprising just a few OFDM symbols.

The wireless communication system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g., DFT-s-OFDM. Other waveforms, like non-orthogonal waveforms for multiple access, e.g., filter-bank multicarrier (FBMC), generalized frequency division multiplexing (GFDM) or universal filtered multi carrier (UFMC), may be used. The wireless communication system may operate, e.g., in accordance with the LTE-Advanced pro standard or the NR (5G), New Radio, standard.

The wireless network or communication system depicted in FIG. 1 may by a heterogeneous network having distinct overlaid networks, e.g., a network of macro cells with each macro cell including a macro base station, like base station gNB1 to gNB5, and a network of small cell base stations (not shown in FIG. 1), like femto or pico base stations.

In addition to the terrestrial wireless networks describe above, non-terrestrial wireless communication networks exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the NR (5G), new radio, standard.

In mobile communication networks, for example in a network like that described above with reference to FIG. 1, like an LTE or 5G/NR network, there may be UEs that communicate directly with each other over one or more sidelink (SL) channels, e.g., using the PC5 interface. UEs that communicate directly with each other over the sidelink may include vehicles communicating directly with other vehicles (V2V communication), vehicles communicating with other entities of the wireless communication network (V2X communication), for example roadside entities, like traffic lights, traffic signs, or pedestrians. Other UEs may not be vehicular related UEs and may comprise any of the above-mentioned devices. Such devices may also communicate directly with each other (D2D communication) using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are not within one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station cannot provide sidelink resource allocation configuration or assistance for the UEs, and/or
may be connected to the base station that cannot support NR V2X services, e.g., GSM, UMTS, LTE base stations.

When considering two UEs directly communicating with each other over the sidelink, e.g., using the PC5 interface, one of the UEs may also be connected with a BS, and can thus relay information from the BS to the other UE via the sidelink interface. Such relaying can be performed in the same frequency band (in-band-relay) or another frequency band (out-of-band relay) can be used. In the first case, communication on the Uu and on the sidelink may be decoupled using different time slots as in time division duplex, TDD, systems.

FIG. 2a is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signalling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 2b is a schematic representation of an out-of-coverage scenario in which the UEs directly communicating with each other are either not connected to a base station, although they can be physically within a cell of a wireless communication network, or some or all of the UEs directly communicating with each other are communicating with/connected to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 2b which is the out-of-coverage scenario does not necessarily mean that the respective mode 2 UEs (in NR) or mode 4 UEs (in LTE) are outside of the coverage 200 of a base station, rather, it means that the respective mode 2 UEs (in NR) or mode 4 UEs (in LTE) are not served by a base station, are not connected to the base station of the coverage area, or are connected to the base station but receive no SL resource allocation configuration or assistance from the base station. Thus, there may be situations in which, within the coverage area 200 shown in FIG. 2a, in addition to the NR mode 1 or LTE mode 3 UEs 202, 204 also NR mode 2 or LTE mode 4 UEs 206, 208, 210 are present.

Naturally, it is also possible that the first vehicle 202 is covered by the gNB, i.e. connected with Uu to the gNB, wherein the second vehicle 204 is not covered by the gNB and only connected via the PC5 interface to the first vehicle 202, or that the second vehicle is connected via the PC5 interface to the first vehicle 202 but via Uu to another gNB, as will become clear from the discussion of FIGS. 4 and 5.

FIG. 3 is a schematic representation of a scenario in which two UEs directly communicating with each, wherein only one of the two UEs is connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204, wherein only the first vehicle 202 is in the coverage area 200 of the base station gNB. Both vehicles 202, 204 are connected directly with each other over the PC5 interface.

FIG. 4 is a schematic representation of a scenario in which two UEs directly communicating with each other, wherein the two UEs are connected to different base stations. The first base station gNB1 has a coverage area that is schematically represented by the first circle 200₁, wherein the second station gNB2 has a coverage area that is schematically represented by the second circle 200₂. The UEs directly communicating with each other include a first vehicle 202 and a second vehicle 204, wherein the first vehicle 202 is in the coverage area 2001 of the first base station gNB1 and connected to the first base station gNB1 via the Uu interface, wherein the second vehicle 204 is in the coverage area 200₂ of the second base station gNB2 and connected to the second base station gNB2 via the Uu interface.

A scenario described herein may not only comprise nodes like base stations, UEs, IoT devices, but also transmission reception points, TRPs.

In a wireless communication system by way of non-limiting example such as described above, a user equipment, UE, device may be connected, according to a known concept, to the network via one or more base stations or gNBs. Due to the limited coverage range per BS and the intention to provide uninterrupted coverage over a large area, the BSs are distributed in space such that their coverage footprints overlap, thus providing coverage and therefore connectivity options for a UE located within this larger joint coverage area of the multiple BSs.

In order to make this multi-BS network manageable and efficient, each BS is identified as a cell using a cell identifier and a network identifier (PLMN). A UE will then initially register to one BS, mostly the strongest selecting the appropriate PLMN, the UE has to be subscribed to the PLMN, mobile network operator, MNO, or the MNO has a roaming agreement. When the UE is granted access to the MNO's network, the UE will be configured with network and BS specific parameters including cell-IDs from neighboring BSs in order to prepare the UE for network monitoring and mobility support. When the UE moves within the coverage area it might increase distance to its original BS and get close to another BS. This may result in reduced RSRP with the serving BS and an increased RSRP with another BS closer by. As a consequence the signal-to-interference ratio (SIR) between the serving BS and the close by BS will decrease which might end in an undetectable signal received from the serving BS. This is a general well-understood problem which is solved since the first generation of cellular communication by handing the service from one BS to the next, selecting the serving BS to the one with the strongest RSRP at the UE. The involved mechanism is called cellular handover within a network and involves monitoring of signal strength, e.g., RSRP to be as nearby and initiation of a handover request/procedure by the UE when the observed SINR becomes unfavorable and better alternative of serving BSs are available.

While such network design and related connectivity is well-understood and solid in known concepts, the drawback of such design is signal design imminent due to the independence of signals transmitted and associated with each of the multiple BSs. Such signal broadcasted by each BS are necessary to identify the BS itself and to mark/identify, e.g., spatial beams, frequency bands and the like. The concept of cellular signal design associated with each BS and related to transmission signals result in inter-cell interference since different BS transmit different identification signals and control and user plane signals. This leads to the fact that UE will experience fluctuating SIR levels no matter how optimized the handover procedure between BS is implemented.

There is, thus, a need to improve wireless communications.

It is noted that the information in the above section is only for enhancing the understanding of the background of the invention and therefore it may contain information that does not form conventional technology and is not yet known to a person of ordinary skill in the art.

### SUMMARY

An embodiment may have a user equipment, UE, configured for operating in a wireless communication network that utilizes resources of a time/frequency grid; wherein the UE is adapted to report to the wireless communication network a connectivity information associated to a first connectivity option of the UE to the wireless communication network and associated to a second connectivity option of the UE to the wireless communication network; and/or wherein the UE is adapted to receive, during a same instance of time, and decode a first signal received from a first transmission/reception point, TRP, and a second signal received from a second TRP, the first signal and the second signal occupying resources in the same time/frequency grid.

Another embodiment may have a wireless communication network comprising: a device, according to the invention; a set of transmission/reception points, TRPs, including the first TRP and the second TRP, each TRP adapted to provide a signal in the wireless communication network to collaboratively transmit signals to the UE; wherein the wireless communication network is configured for controlling the first TRP and the second TRP. 40. A base station configured to operate in a wireless communication network to provide communication to a user equipment, UE, the base station adapted to receive a report from a member of the wireless communication network, indicating a set of beams of different transmission/reception points, TRPs, suitable for the UE for communication; and to inform at least a different base station about the set of beams; or the base station adapted to receive a report from a member of the wireless communication network indicating at least one beam to be excluded for a multi-TRP operation for the UE; and to operate accordingly.

Another embodiment may have a base station configured to operate in a wireless communication network, the base station adapted to receive an information, e.g., from another base station, relating to at least a subset of a set of beams; and to control a transmission/reception point TRP to form a beam from the subset according to the information, e.g., to provide a signal to a device.

Another embodiment may have a device such as a user equipment, UE, configured for operating in a wireless communication network that utilizes resources of a time/frequency grid; wherein the UE is adapted to report to the wireless communication network about a lack of capability indicating that the UE is incapable of processing, a first signal received from a first transmission/reception point, TRP, and a second signal received from a second TRP, the first signal and the second signal occupying resources in the same time/frequency grid and received during a same instance of time.

Another embodiment may have a method for operating a device such as a user equipment, UE, for operating in a wireless communication network that utilizes resources of a time/frequency grid the method comprising: reporting, with the device, to the wireless communication network a connectivity information associated to a first connectivity option of the device to the wireless communication network and associated to a second connectivity option of the device to the wireless communication network; and/or receiving, with the device and during a same instance of time, and decoding a first signal received from a first transmission/reception point, TRP, and a second signal from a second TRP, the first signal and the second signal occupying resources in the same time/frequency grid.

Another embodiment may have a method for operating a wireless communication network, the method comprising: operating a user equipment, UE; operating a set of transmission/reception points, TRPs, including a first TRP and a second TRP, each TRP adapted to provide a signal in the wireless communication network to collaboratively transmit signals to the UE; such that the wireless communication network controls the first TRP and the second TRP.

Another embodiment may have a method for operating a base station to provide communication to a user equipment, UE, in a wireless communication network, the method comprising: receiving and decoding a report from a member of the wireless communication network, indicating a set of beams of different transmission/reception points, TRPs, suitable for the UE for communication; and informing at least a different base station about the set of beams; or receiving a report from a member of the wireless communication network indicating at least one beam to be excluded for a multi-TRP operation for the UE; and operating the base station accordingly.

Another embodiment may have a method for operating a base station in a wireless communication network, the method comprising: receiving an information relating to at least a subset of a set of beams; and controlling a transmission/reception point TRP to form a beam of the subset according to the information.

Another embodiment may have a method for operating a device such as a user equipment, UE, in a wireless communication network that utilizes resources of a time/frequency grid, the method comprising: reporting to the wireless communication network about a lack of capability indicating that the device is incapable of processing a first signal received from a first transmission/reception point, TRP, and a second signal received from a second TRP, the first signal and the second signal occupying resources in the same time/frequency grid and received during a same instance of time.

Another embodiment may have a non-transitory digital storage medium having a computer program stored thereon to perform the method for operating a device such as a user equipment, UE, for operating in a wireless communication network that utilizes resources of a time/frequency grid the method comprising: reporting, with the device, to the wireless communication network a connectivity information associated to a first connectivity option of the device to the wireless communication network and associated to a second connectivity option of the device to the wireless communication network; and/or receiving, with the device and during a same instance of time, and decoding a first signal received from a first transmission/reception point, TRP, and a second signal from a second TRP, the first signal and the second signal occupying resources in the same time/frequency grid, when said computer program is run by a computer.

### BRIEF DESCRIPTION OF THE DRAWINGS

Embodiments of the present invention will be detailed subsequently referring to the appended drawings, in which:

FIG. 1a shows a schematic representation of an example of a wireless communication system;

FIG. 1b is a schematic representation of an example of a radio access network RANn that may include one or more base stations;

FIG. 2a is a schematic representation of an in-coverage scenario in which UEs directly communicating with each other are connected to a base station;

FIG. 2b is a schematic representation of an out-of-coverage scenario in which UEs directly communicating with each other receive no SL resource allocation configuration or assistance from a base station;

FIG. 3 is a schematic representation of a partial out-of-coverage scenario in which some of the UEs directly communicating with each other receive no SL resource allocation configuration or assistance from a base station;

FIG. 4 is a schematic representation of an in-coverage scenario in which UEs directly communicating with each other are connected to different base stations;

FIG. 5 is a schematic representation of a wireless communication system comprising a transceiver, like a base station or a relay, and a plurality of communication devices, like UEs, according to an embodiment;

FIG. 6 shows a schematic diagram of a part of a wireless communication network according to an embodiment;

FIG. 7 shows a schematic block diagram of a wireless communication network according to an embodiment having at least two base stations;

FIG. 8 shows a schematic diagram to show a possible measurement of RSRP observed by a UE moving from a first serving BS to a second serving BS according to an embodiment;

FIG. 9 shows a schematic representation of different grids representing UE receive antennas/layers versus BS/TRP antennas/antenna ports/beams according to an embodiment;

FIG. 10 shows a schematic diagram of a scenario of a wireless communication network according to an embodiment of which two base stations or TRPs are shown that serve the UE by using superimposed spatial beams according to an embodiment;

FIG. 11a-c show schematic block diagrams to illustrate of different degrees of collaboration between BSs according to an embodiment;

FIG. 12a shows a known mapping of beam information and frequency time domain contained;

FIG. 12b shows an example of a proposed mapping of beam information in an identical frequency time domain modifying FIG. 12a according to an embodiment;

FIG. 13 shows a possible antenna port mapping matrix according to an embodiment;

FIG. 14 shows an example of a spatial realization of the resource mapping shown in FIG. 13 according to an embodiment;

FIG. 15 shows an example scenario in connection with embodiments where UEs are located within the coverage of base stations wherein one of the UEs may be moved;

FIG. 16a-b show schematic illustrative examples of beam measurements that may be made with UEs according to an embodiment when receiving signals from two BSs;

FIG. 17a shows a combination of FIGS. 16a and 16b;

FIG. 17b shows for each UE of FIG. 16a-b a maximum RSRP level to be determined according to an embodiment;

FIG. 17c shows remaining beams after a selection procedure according to an embodiment;

FIG. 17d shows a schematic diagram to illustrate an obtained RSRP improvement according to an embodiment;

FIG. 17e an overview of the wanted joint TRP beam pairs and interfering TRPs according to an embodiment;

FIG. 18 a schematic block diagram showing a part of a network where a report sent from a UE to a BS may also be received by other basestions according to an embodiment;

FIG. 19 shows a schematic representation of a wireless communication network according to an embodiment illustrating a concept of obtaining overall knowledge based on reports;

FIG. 20 shows a schematic representation of a wireless communication network according to an embodiment, wherein a set of BS is shown in connection with different coverage areas;

FIG. 21 shows a schematic representation of a measurement at a UE based on RSRP values identifying beams from two base stations; and

FIG. 22 illustrates an example of a computer system on which units or modules as well as the steps of the methods described in accordance with the inventive approach may execute.

### DETAILED DESCRIPTION OF THE INVENTION

Equal or equivalent elements or elements with equal or equivalent functionality are denoted in the following description by equal or equivalent reference numerals.

In the following description, a plurality of details is set forth to provide a more thorough explanation of embodiments of the present invention. However, it will be apparent to one skilled in the art that embodiments of the present invention may be practiced without these specific details. In other instances, well-known structures and devices are shown in block diagram form rather than in detail in order to avoid obscuring embodiments of the present invention. In addition, features of the different embodiments described hereinafter may be combined with each other, unless specifically noted otherwise.

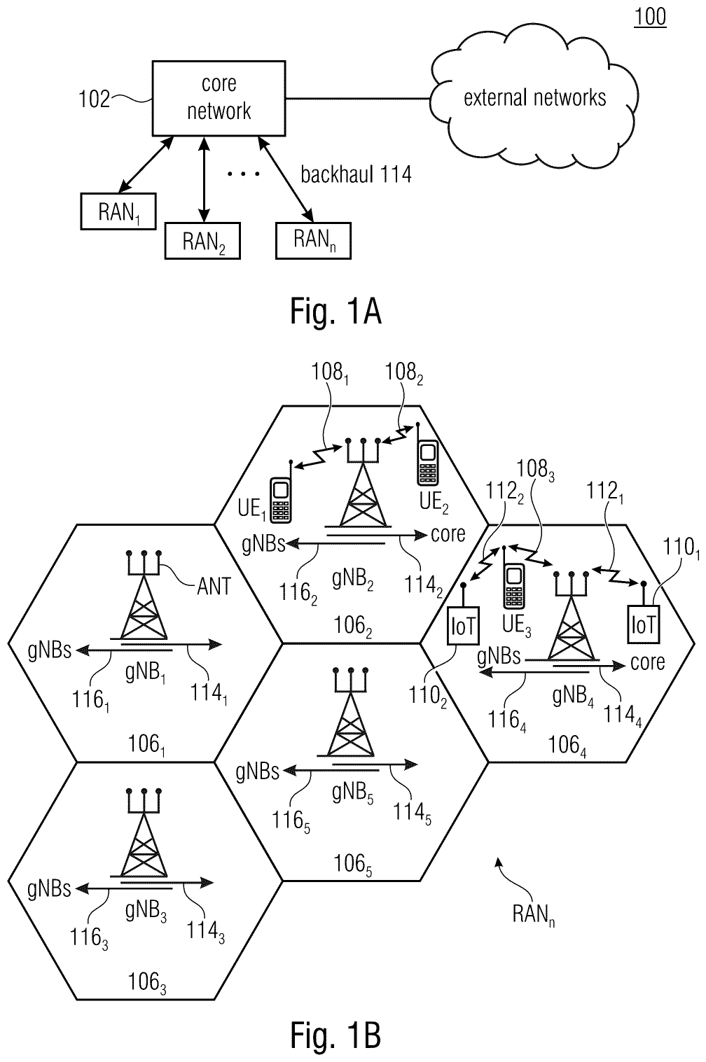

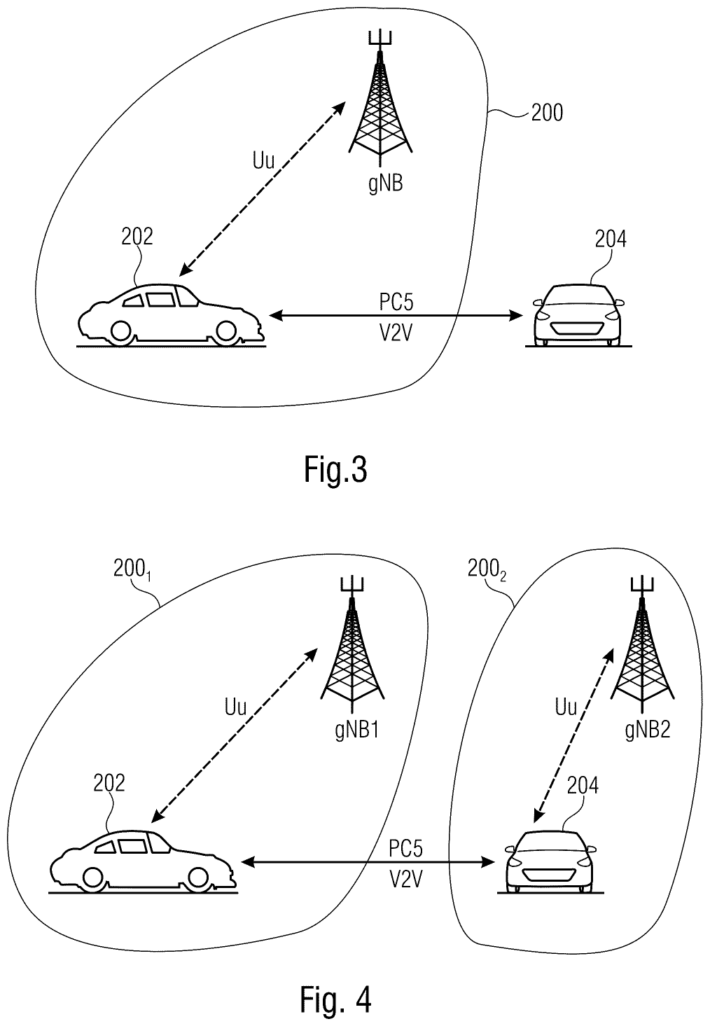

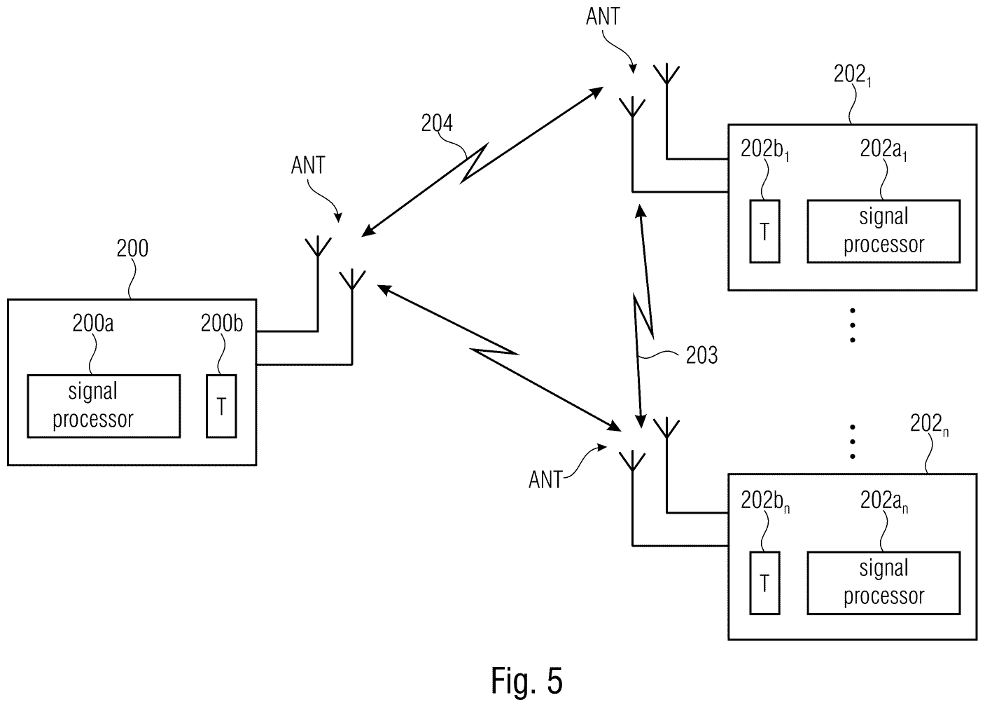

Embodiments of the present invention may be implemented in a wireless communication system or network as depicted in FIGS. 1 to 4 including a transceiver, like a base station, gNB, or relay, and a plurality of communication devices, like user equipment's, UEs. FIG. 5 is a schematic representation of a wireless communication system comprising a transceiver 200, like a base station a transmission reception point, TRP, or a relay, and a plurality of communication devices 202₁ to 202n, like UEs. The UEs might communicated directly with each other via a wireless communication link or channel 203, like a radio link (e.g., using the PC5 interface (sidelink)). Further, the transceiver and the UEs 202 might communicate via a wireless communication link or channel 204, like a radio link (e.g., using the uU interface). The transceiver 200 might include one or more antennas ANT or an antenna array having a plurality of antenna elements, a signal processor 200a and a transceiver unit 200b. The UEs 202 might include one or more antennas ANT or an antenna array having a plurality of antennas, a processor 202a1 to 202an, and a transceiver (e.g., receiver and/or transmitter) unit 202b1 to 202bn. The base station 200 and/or the one or more UEs 202 may operate in accordance with the inventive teachings described herein.

Some embodiments described herein relate to a cell of a wireless communication network. Such a cell may be considered, e.g., in 3GPP terms, as being associated with a cell-ID, wherein the cell-ID is broadcasted within the MIB which is part of all the beams (SSBs) transmitted by this base station/TRP. When referring to handover between cells, certain SSB signals from other TRPs may become stronger or comparable to the cell the UE is connected to. According to embodiments, based thereon, the Cell-ID can be transmitted by a single TRP or by multiple TRPs at the same time using the same resource element (RE).

As discussed in connection with network 100, a wireless communication network may comprise one or more transmission reception points, TRPs and a base station may comprise one or a plurality of TRPs. According to an embodiment, the base station may comprise a central unit, CU, that is connected to one or more distributed units, DU, and/or radio units RU, that may be operated in a joint or coordinated manner by the CU and that may forward received measurement reports to the CU.

When referring again to the handover procedure in known networks, summarizing the relevant aspects of known concepts in cellular connectivity may lead to the conclusion that the inter-cell interference experienced by each UE has to be reduced or even eliminated by a new form of network to UE identification and signaling procedures, allowing better signal quality for control and/or user plane data and reduced or even no need of handover procedures creating an impact on link latency and fluctuations on throughput during handovers between BSs. The envisioned “cell-less” design of a multi-BS network is often called cell-free MIMO or cell-free network and symbolizes a novel type of network operation which from a UE perspective allows a connectivity experience which is more or less like remaining in the same cell even when moving through a larger area and in reality the signals transmitted to the UE and received from the UE will go via different BSs.

The purpose of embodiments of the underlying invention is to provide methods and devices that are related to a procedure to facilitate such a vision of a cell-less network considering the impact on current standardization and related procedures. The provided procedures include but are not limited to the following:
1. Channel state information (CSI) measured by the UE in downlink (DL) and reported in uplink (UL) to at least one of the base stations (BS);
2. Transmission configuration indication (TCI), e.g., in DL, used by the UE receiver;
3. TCI, transmitted by the UE in UL. For example, providing UL beam announcement;
4. TCI, transmitted by the BS in DL and received by the UE. For example, for beam management, for SRS (marking resources by RS) and for SRI (addressing resources to be used).

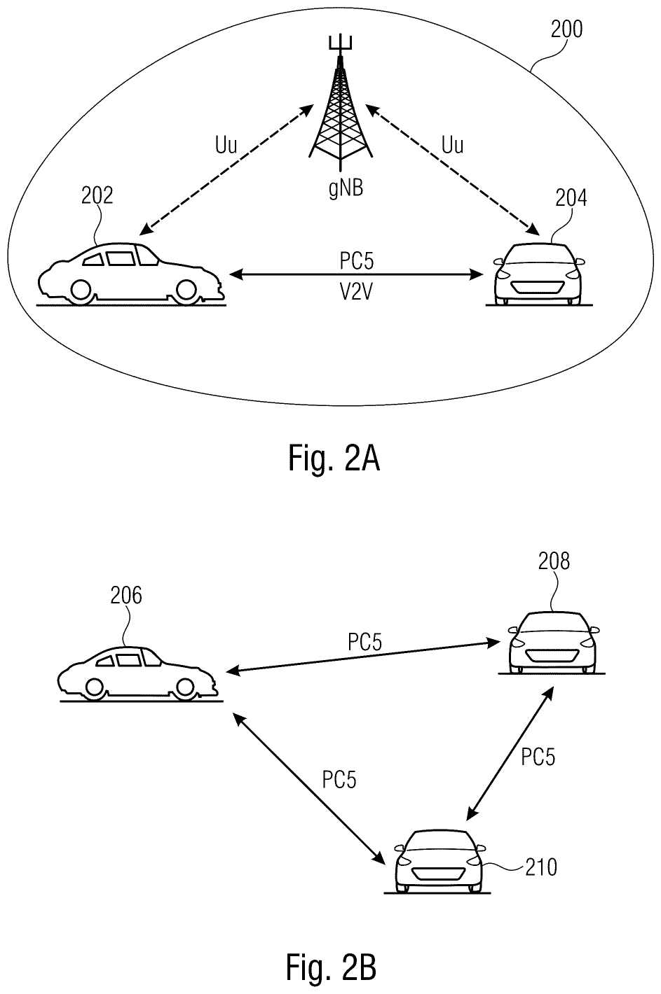

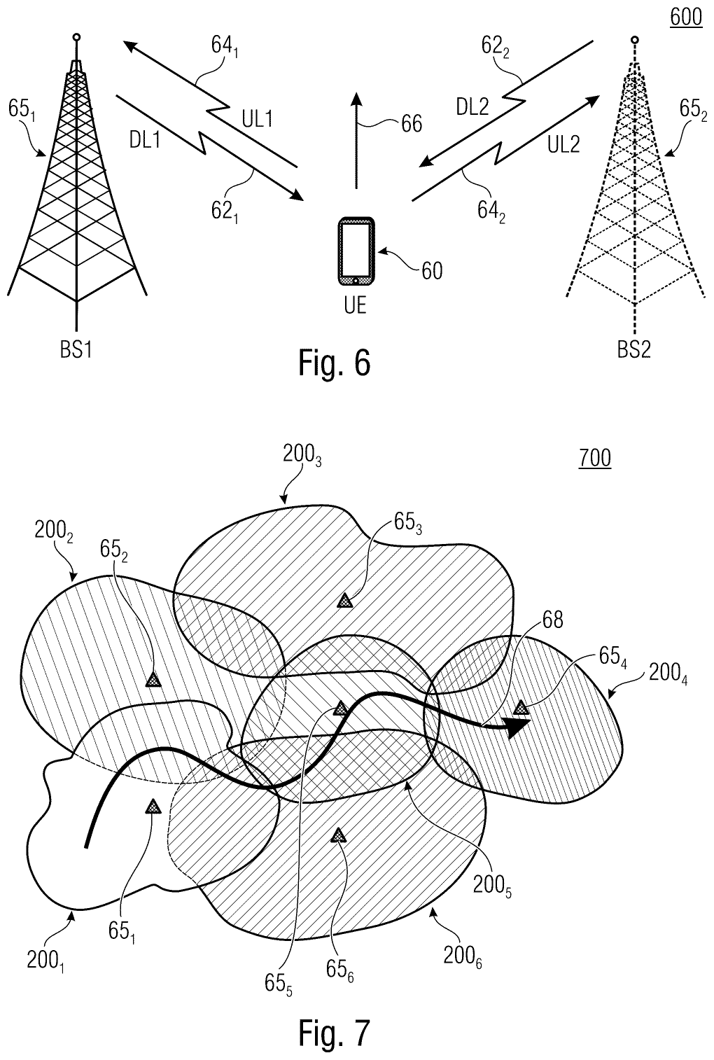

FIG. 6 shows a schematic diagram of a part of a wireless communication network 600 according to an embodiment having a UE 60 according to an embodiment and base stations 65₁ and 65₂ are implemented according to the disclosure described herein. For example, the communication scenario illustrated in FIG. 6 may comprise a device 60, e.g., a UE, receiving signals from TRPs or base stations and being in coverage of at least the two base stations 65₁ and 65₂ using the same band for communication with the UE 60. This is, for example, a classical 4G or 5G cellular scenario with full frequency reuse. The base station 65₁ and/or 65₂ may be a base station of network 100 and/or as described in FIGS. 2-4.

When the UE 60 is receiving signals from the at least two base stations 65₁ and 65₂ at the same time, and while the UE 60 is detecting the signal from one of the base stations 65₁ and 65₂ as its serving base station, then the signal transmitted by all other base stations are perceived by the UE 60 as interference in known scenarios. Interference in this context may refer to all kind of signals transmitted by the multitude of base stations which are base station specific and mapped on the same time and frequency resources by at least two base stations providing coverage to the UE 60. Communication between the UE 60 and the base station 65₁ may comprise a downlink 62₁ and/or an uplink 64₁. Communication between the UE 60 and the base station 65₂ may comprise a downlink 62₂ and/or an uplink 64₂. The device 60, e.g., a user equipment or a different device such as an IoT (internet-of-things) device or a base station or the like, may report, to the wireless communication network 600 a connectivity information associated with a first connectivity option of the UE 60 to the wireless communication network 600 and associated a second connectivity option of the UE to the wireless communication network. For example, the UE 60 may transmit a connectivity signal 66 comprising the connectivity information. The connectivity information may comprise, for example, a channel state information, CSI, wherein the connectivity option may refer to a beam the UE may provide or use for transmission or reception of a signal to one or more base stations, e.g., a specific base station or a non-specific base station. Alternatively or in addition, the first connectivity option may refer to a multipath component that the UE may use or benefit from when communicating in the wireless communication network 600.

The connectivity information and/or the connectivity option may be further specific, e.g., when identifying a specific base station and/or a specific TRP. In context with a TRP, it is to be noted that a base station being subject of embodiments described herein may comprise one or more TRPs, wherein TRPs may also be located outside a base station.

Beside the first connectivity option, the connectivity information contained in the connectivity signal 66 may further be associated to a second connectivity option of the UE, e.g., related to a same or different base station and/or TRP. That is, the UE may inform the network about its connectivity options with regard to at least two base stations and/or TRPs.

Alternatively or in addition, UE 60 may be adapted to receive, during a same instance of time, e.g., simultaneously whilst this does not require a complete overlap in time but also refers to a partial overlap, a first signal received from a first TRP and a second signal received from a second TRP. For example, the first signal might be received via downlink 62₁ and the second signal might be received via downlink 62₂ during a same time. The UE 60 may be configured for decoding both signals, wherein the signals occupy resources in a same time/frequency grid. For example, the different cells operated by base stations 65₁ and 65₂ may be operated in full-frequency reuse and therefore the use of a common time-frequency grid may be used by the base stations simultaneously. Reference signals, RSs, that may indicate the connectivity options may be different or may be same for different TRPs. Such same or different RS may be mapped to the same or different resource elements, RE at different TRPs.

For example, a signal such as an RS may be distributed across antenna ports and/or TRPs. If different reference signals are transmitted from different locations then the channels associated with each TRP/location may distinguished and/or identified by the evaluating device. If multiple TRPs send the same RS on the same resource element, then the UE may observe a compound or unresolvable superposition on the plurality of channels which is avoided by the solution described herein. A device in accordance with embodiments may be configured for receiving multiple distinguishable signals from multiple sources, e.g., TRPs, and for providing feedback such as a report described herein, for at least one or the plurality of signals. Such a report may be provided commonly for at least two, a selected subset or all of the received signals or may be provided individually for a single signal. For example, two different sources may transmit the distinguishable signals so as to comprise different RS, same RS mapped on different REs, and/or same RS used with known and distinguishable modifications such as phase shifts on Zhadoff-Chu sequences, e.g., as used to identify the three sectors of a same gNB. Alternatively or in addition, an overlay of power between the same RS on the same REs with known pattern and/or synchronization may be used.

Embodiments of the present invention deviate from known networks by proposing to collaboratively using or reusing resources to transmit data to a UE or a group of UEs. The resources are, thus, used to form collaborative sets of TRPs behaving like virtual BSs created, e.g., on demand and the set to be selected depending on the channel conditions observed and reported by the UE. In other words, some of the embodiments relate to switching a known interference signal into a signal providing benefit for the UE. 15:50

As indicated above, at least some of the embodiments described herein are to identify and/or provide means to design the necessary base station specific signals, including reference signals, such that the interference experienced by the UE is reduced when compared to known systems. Alternatively or in addition, embodiments allow to create a new kind of user-centric network that allows UE mobility without having to rely on the traditional mechanisms of cell identification and BS-to-BS handover. Related methods and concepts affect existing procedures used in a wireless communication system, including but not limited to the following:
1. Channel state information (CSI) measured by the UE in downlink (DL) and reported in uplink (UL) to at least one of the base stations (BS);
2. Transmission configuration indication (TCI), e.g., in DL, used by the UE receiver;
3. TCI, transmitted by the UE in UL. For example, providing UL beam announcement;
4. TCI, transmitted by the BS in DL and received by the UE. For example, for beam management, for SRS (marking resources by RS) and for SRI (addressing resources to be used).

All four of those procedures listed above, each of which is defined in a wireless standard, may be affected by the solutions provided by the embodiments and therefore are considered to be impacted in such standards.

Some of the embodiments are based on the finding that usually a UE has one RRC connection to one BS or, in case of MUSIM, to two BSs. In the context of embodiments described herein, this might need changes to the mechanism of RRC connection and signaling. This might include that the RRC connection is terminated in one location but still wirelessly provided through multiple TRPs e.g., BS, while several BS/TRPs are involved in providing the cell-free links for a control plane and a user plane.

FIG. 7 shows a schematic block diagram of a wireless communication network 700 according to an embodiment having, by way of non-limiting example at least two base stations such as at least 3, at least 4, at least 5 or more, e.g., at least 10, at least 20 or at least 100. FIG. 7 illustrates a number of six base stations to show the concept of overlapping coverage areas 200₁ to 200₆ provided by base stations 65₁ to 65₆. In the shown multi-cell scenario where multiple BSs 65₁ to 65₆ create an overlapping coverage area to provide uninterrupted connectivity to UEs distributed in that area, e.g., a UE moving along a path 68. Classically, these BSs 65₁ to 65₆ may be identified by a cell ID when operating when according to a known configuration.

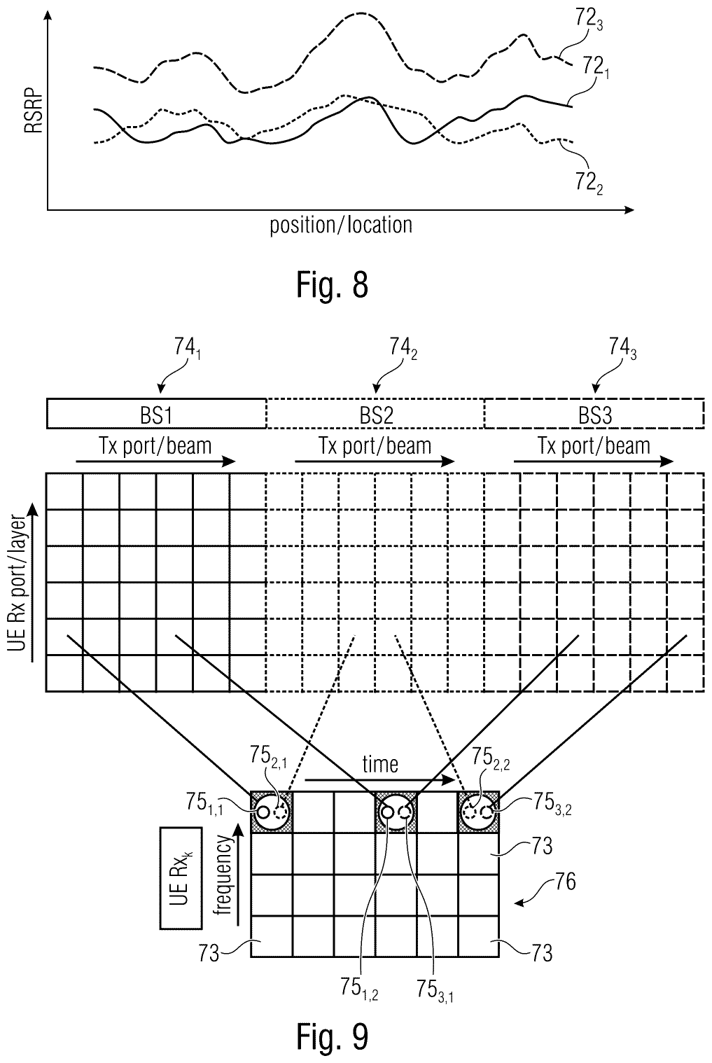

FIG. 8 shows a schematic illustration to show a possible measurement of RSRP observed by a UE moving from a first serving BS (curve 72₁) to a second serving BS (curve 72₂). When the UE could benefit from the superposition of signal strength then the aggregate line, curve 72₃, would be the resulting effective RSRP. Depending whether the signals are combined coherently, i.e., in a particular phase relationship, which may be the controlled and/or joint transmission of the BS/TRPs, or non-coherently, i.e., the BSs transmit signals with fixed or arbitrary phase relationship to each other, the superposition of the signals may result in adding or subtracting amplitudes, in the coherent case, or simply adding signal power in the randomized non-coherent case. In other words, in FIG. 8 there are shown signals from two separate base stations that are superposed to produce a stronger signal and hence improved RSRP, see curve 72₃.

FIG. 9 shows different grids 74₁ to 74₃ representing UE receive antennas/layers versus BS/TRP antennas/antenna ports/beams, used by three different base stations/TRPs at the same time, wherein certain resource elements 73 of the grids 74₁ to 74₃ are coordinated to be used to communicate with a particular UE or group of UEs, such that the UE benefits from a controlled superposition of beams transmitted from different BSs providing useful signals for the UE. Such beams may be provided or created by antenna arrays at the base station and/or using reconfigurable intelligent surfaces, RIS, as dominant and controllable multipath components, MPCs.

A resource grid 76 may comprise resource elements, REs, 73 that may be associated with UE receiver branch k. The resource grid 76 may comprise REs 73 arranged in time (e.g. OFDM symbols) and frequency (e.g., OFDM sub-carriers); wherein the CSI-RS 75_{a,b} received from the base station are superimposed onto the same REs in the example given. In FIG. 9 CSI-RS 75_{a,b} are labeled with indices a and b, index a indicating the transmitter transmitting the RS and index b indicating an index of RE. As may be seen from FIG. 9, based on the joint control of TRPs and/or base stations the UE may receive, at least in some REs 73 of grid 76, signals from different base stations. Embodiments allow to make use of both of the signals.

The coordination of resources and associated RS can refer to at least one of:
TX antennas (CSI-RS)
beams (port selection code book, precoded CSI-RS) e.g., 64 or a different number of such beams can be indexed and identified;
SSB (cell, beam, . . . )
The overall effect of such superposition of spatial resources may relate to at least one of:
   1. Increase or improve RSRQ for a UE or a group of UEs at a particular location/within a particular area and/or
   2. Reduce UE specific inter-BS/inter-TRP interference by carefully selecting RS and transmitted user and/or control plane data and/or
   3. Reduced inter-layer/inter-UE interference in a multi-UE scenario.

The combination of a BS and a RIS may be considered as a BS and an associated TRP, wherein the two signals/beams may be coherent, because the signal from the RIS originates from the BS and therefore has a deterministic phase relationship. If a RIS is replaced by a repeater or relay, the signals from the BS and the repeater/relay may be received as non-coherent signals by a UE and therefore might need to be treated differently compared to the coherent case. This may lead to the conclusion that the use of a RIS may help to reduce complexity to maintain coherent signals across multiple MPCs created by the RIS. It is noted a beam correspondence, BC, procedure is usually supported in RRC connected mode. In FR2 a BC capable UE may use BC already for initial access. In view of the embodiments presented herein, a device such as a UE may simultaneously execute a BC procedure to a single a r at least two basestations.

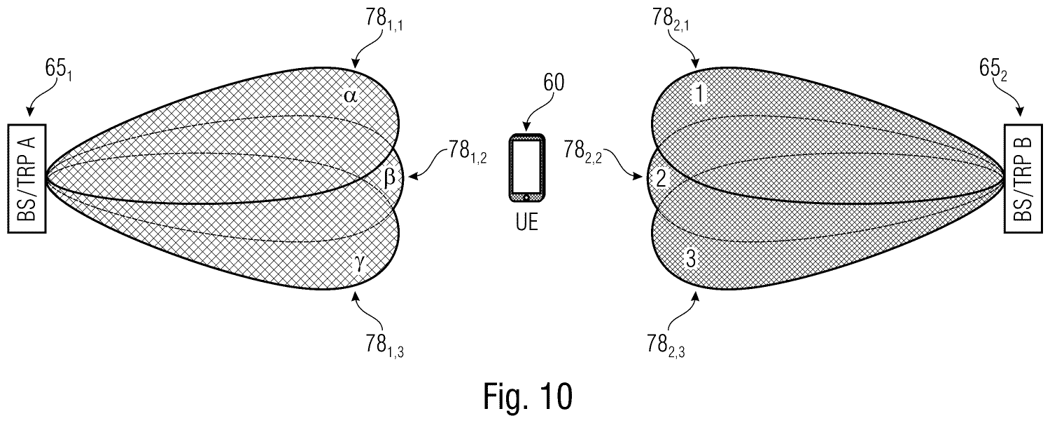

FIG. 10 shows a scenario of a wireless communication network according to an embodiment of which two base stations or TRPs 65₁ and 65₂ are shown that serve the UE 60 by using superimposed spatial beams 78 that are labeled as beams 78_{i,j}, wherein parameter i relates to the index of a base station/TRP 65₁, 65₂ respectively and the parameter j relates to a number to distinguish between the beams of a single TRP or base station.

To support the understanding of FIG. 10, the beams of base station 65₁ are further marked by Greek letters α, β and γ whilst the beams of base station 65₂ are marked by numbers 1, 2 and 3.

Such beams may be created and marked through the use of reference signals from the individual base station or from a collaboration of at least two base stations. In FIG. 10, the two options are referred to as:
Option A: signals transmitted from one or more BS/TRP are identified by individual, separate and/or unique RSs. The individual RSs mark a beam or port associated with each TRP. The UE may receive these signals and can thus identify the individual beams associated with the one or more BS/TRP;
Option B: signals transmitted collaboratively from multiple BSs/TRPs are identified by “joint RSs”. The joint RSs may mark a beam or port. The UE may receive these signals and can thus identify the collaborative beams created by the multiple BS/TRP. Joint RS can mean, with regard to no networks, that either existing reference signals are transmitted from different TRPs and/or that newly defined RS are used in connection with embodiments described herein. The jointly used REs, e.g., for channel estimation may be marked by different basestations with identical RSs or distinguishable RSs. This allows the channels between the UE and the basestations to be measured in combination, e.g., using identical RSs, or in separation, e.g., using distinguishable RSs.

Option A and B are modes of cell-free operation. Option A may be considered to be closer to the current type 5G-NR mapping of RS to SSBs/beams/BSs/TRPs while Option B may be more advanced using a collaboration of multiple TRPs that reuse existing RSs or new types of RSs referred to as joint RS, to SSB/beams.

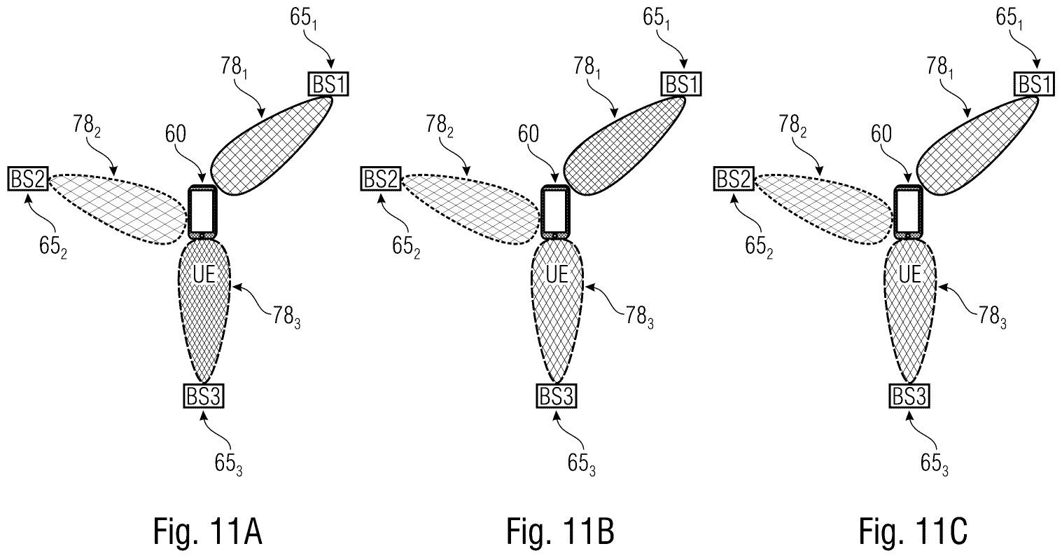

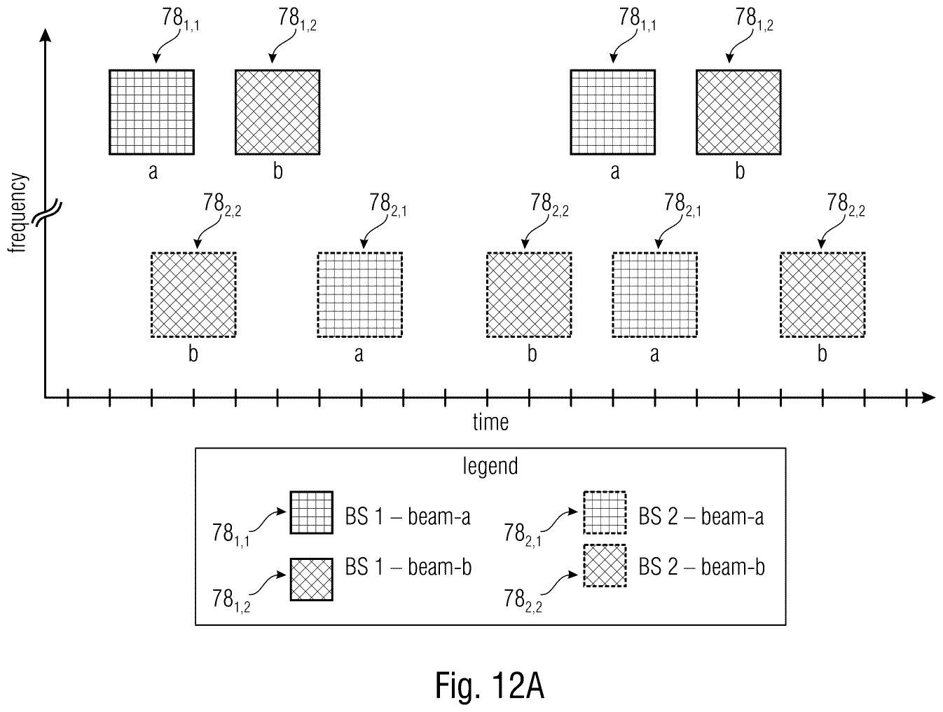

Both options may allow to operate the system within the existing MIMO schemes using MIMO feedback of type 1 (port selection) and/or type 2 (requested combination of several beams with dedicated phase and amplitude combinations). Furthermore, both options may be compatible with the MIMO feedback for multiple layers (rank 2 or higher, maximally up to eight layers). Further examples in connection with embodiments described herein are explained by use of FIGS. 11a-c. Therein, examples of three multi-beam base stations 65₁ to 65₃ are shown. In the configuration of FIG. 11a, base stations 65₁ to 65₃ may operate with independent non-collaborative beams, e.g., TX beams 78i. In FIG. 11b, a non-traditional base station configuration with inter-dependent, i.e., collaborative, use of beams is shown as indicated with the cross-hatching of beams 78₁ to 78₃ matching each other.

In FIG. 11c a combination of both traditional and non-traditional BSs operating a hybrid arrangement of collaborative and non-collaborative beams is shown where beams 78₂ and 78₃ are operated or controlled jointly or in a collaboration of base stations 65₂ and 65₃ whilst beam 78₁ of base station 65₁ may be operated in a controlled different manner or may be controlled independently.

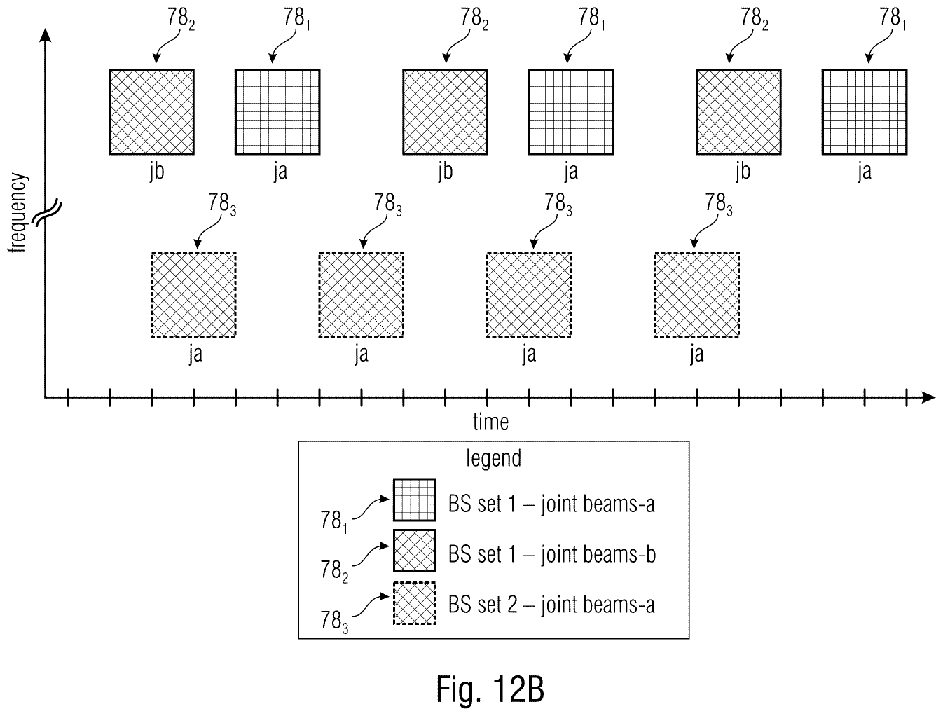

With reference to Option A described above, pilots from different base stations and/or beams of the same and other base stations, reference signals, interfere with the measurements of CSI. FIG. 12a shows a known mapping of beam information and frequency time domain contained, e.g., in SSB.

With reference to Option B above, according to an embodiment, time-frequency resources from BS1 and BS2 are changed, modified or moved to a common BS, e.g., of BS1 only or BS2 only or a different joint set. The same pilots may be used then to transmit the beams. FIG. 12b shows a proposed mapping of beam information in an identical frequency time domain, thus containing information about joint beams in, SSB, therefore being transparent to legacy UEs. For example, the joint base station sets are joint beams 78₁ to 78₃ may be transmitted collaboratively by different TRPs or base stations. Quasi-colocation and TCI may be used inside a neighborhood list of the base stations.

### UE Channel Feedback

In order to facilitate the cell-free operation described before, the network is provided with suitable and sufficient awareness about the connectivity status or options of users, UEs, served under this scheme. Embodiments provide such wireless connectivity awareness through extensions and/or modifications of the existing framework of the channel state information, CSI, feedback framework. Due to the fact that cells and associated identifiers may be usually attached to base station sites and/or sectors the concept proposed herein may provide the means to flexibly allocate identifiers necessary for channel estimation, antenna layer separation, receiving system information and configurations via information elements such as master information block, MIB, system information block, SIB, downlink control information, DCI, managed element, ME, or radio resource control, RRC.

In reference to a known CSI framework, advantageous changes and extensions are described in the following:

### Cell-free Feedback

A feedback or report in accordance with embodiments such as a report provided by a UE may comprise one or more of:
Type I MIMO feedback corresponds to antenna port or beam selection
Type II MIMO (single layer)
   One layer provided by one TRP: TRP2 (1+2) or TRP1 (B+C), or
   One layer provided jointly by two TRPs: (1+C) or (2+B)
Type II MIMO (rank 2)
   Each layer coming from one TRP: TRP1 (B+C)+TRP2 (1+2), or
   Each layer coming from collaborating TRPs: (1+C)+(2+B)

Capability signalling, e.g., by use of a mode information or a capability information may be provided by/to a UE and or by/to a BS (network) is not limited to the following:
UE is “cell-free” (CF) capable
network is “cell-free” (CF) capable

Such capability itself may refer to a capability to measure, identify and/or report:
cell-specific, beam-specific or antenna-port-specific information
   UE is capable of decoding multiple MIBs, SIBs of multiple cells/TRPs
multi-TRP specific (number and combinations of TRPs may be constrained by required processing capabilities at the UE and or by RS resources addressable)
   how many TRPs at the same time
   how many pairs of TRPs at the same time
   list of TRPs may be provided by the network or determined by a CF-capable UE
   such a list can be distributed, e.g., among cell-free, CF,-capable UEs using assistance information message, AIM, over sidelink, SL

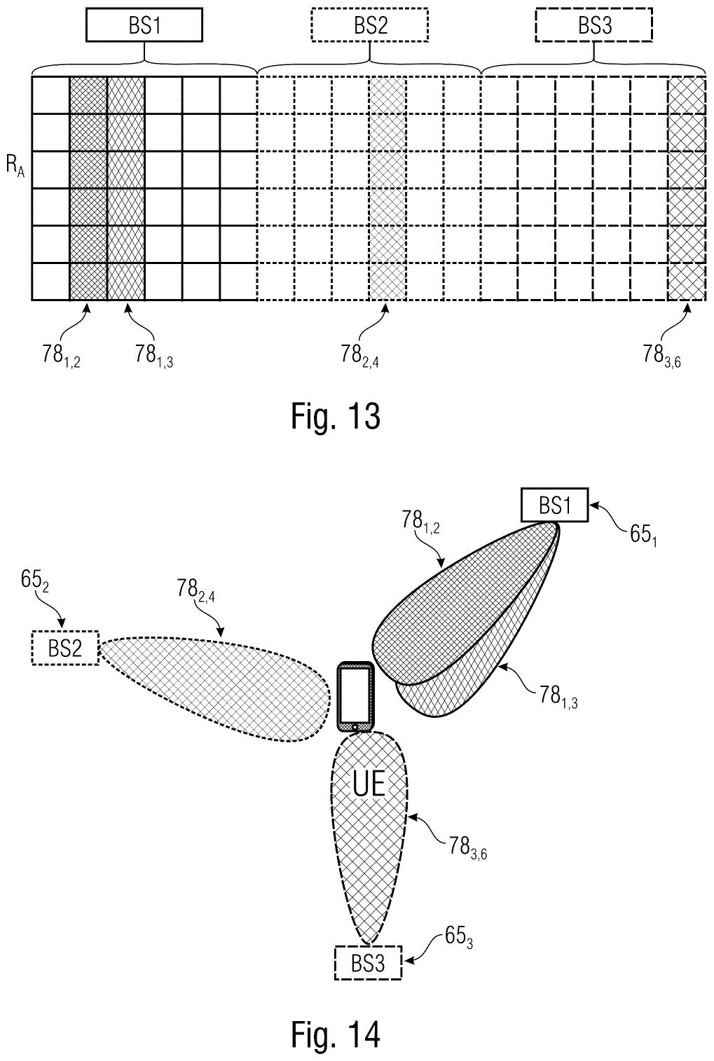

FIG. 13 shows a possible antenna port mapping matrix, wherein the rows represent the number of receive antennas/antenna ports at the cell-free capable UE 60 and the columns represent particular beams/antenna ports addressable/selectable from the multiple BS/TRPs. In FIG. 13 there are shown example beams 78_{1,2}, 78_{1,3}, 78_{2,4} and 78_{3,6} that may be formed with base stations 65₁ to 65₃ shown again in FIG. 14 whilst making reference to FIG. 11a-c. In FIG. 14, an example of the spatial realization of the resource mapping shown in FIG. 13 is shown. This addressing of beams/ports on the basis of best/desirable requested can be done in a codebook like fashion using an index of the spatial resources used by the BSs/TRPs. These indices are used in the MIMO-CSI report of type I or type II provided by the UE. The report can be either CSI-RS based or SSB based or a combination thereof.

The MIMO-CSI feedback provided by the UE will satisfy option A and option B from above, wherein in option A beams and TRPs can be identified and indexed, while in option B the feedback report refers to beam indices only.

Furthermore the UE needs to know how many TRPs are using a specific cell-ID or other specific identifiers/RS jointly.

The following list provides an overview of the different options and/or variants of the meaning of MIB and SIB in the context of cell-free operation of spatial, temporal and frequency resources in a future wireless network.
The classical meaning of an SSB changes from cell specific (single TRP) IDs to new IDs which refer to a combination/collaboration of TRPs and/or combinations/collaborations of beams coming from different TRPs
In a hybrid mode of operation, the network (BSs, TRPs) transmits SSBs (traditional SSBs) and CF-SSBs in superposition and/or in an alternating and/or subsequent and/or scheduled fashion to provide backwards compatibility for legacy UEs
MIB and/or SIB may signal CF-mode/CF-SSB by using new bits reserved or to be newly defined in the standard
Such CF-referring feedback/signalling can be provided across different bands operated by the network and received by the UE (e.g., cross-carrier feedback, cross-carrier CF-mode activation/control)

A UE according to an embodiment may be adapted to report to the wireless communication network; wherein the UE is to include into the report information indicating at least one of:
a type I MIMO feedback, e.g., corresponding to an antenna port or beam selection;
a type II MIMO feedback, e.g., single layer
   at least one layer comprising the first connectivity option and the second connectivity option provided by a single TRP, and/or
   at least one layer comprising the first connectivity option and the second connectivity option provided jointly by the first TRP and the second TRP
a type II MIMO, e.g., rank 2 or at least two layers
   each layer coming from one TRP, e.g., a first TRP providing for an associated first connectivity option and an associated second connectivity option; and/or
   each layer of at least two layers resulting from a connectivity of a first TRP and a connectivity of a second TRP;
parameters referring to signals received from different TRPs such as amplitude, phase and/or timing (absolute or difference values) capability to support multi-TRP or single-TRP operation
signalling a preference to switch from single-TRP to multi-TRP or vice versa

As will be explained below in connection with the connectivity information, the device may thus indicate or request, e.g., using the signalling of the preference, to switch between different TRP modes, e.g., in in view of the parameters referring to signals received from different TRPs.

A UE according to an embodiment may be adapted to report to the wireless communication network, wherein the UE is to include into the report information indicating the connectivity information and information indicating a future position of the UE such as a direction information and/or a velocity information.

A UE according to an embodiment may be adapted to transmit, to the wireless communication network a capability signal indicating at least one of:
the UE is capable to receive and decode the first signal received from the transmission/reception point, TRP, and the second signal received from the second TRP;
the UE is capable of decoding multiple Master Information Blocks, MIBs, and/or system information blocks, SIBs, of multiple cells and/or TRPs;
the number of spatial layers that a UE is capable of supporting in uplink and/or downlink when connected to one or more non-collaborative or collaborative TRPs;
the number of TRPs that may serve the UE at the same time;
the number of TRP sets that may serve the UE at the same time;
a list of TRPs identified by the UE to be suitable for communication;
a list of TRP sets identified by the UE to be suitable for communication; and
a capability to measure a channel between at least one TRP and the UE and/or to measure channels between at least one collaborative set of TRPs and the UE.

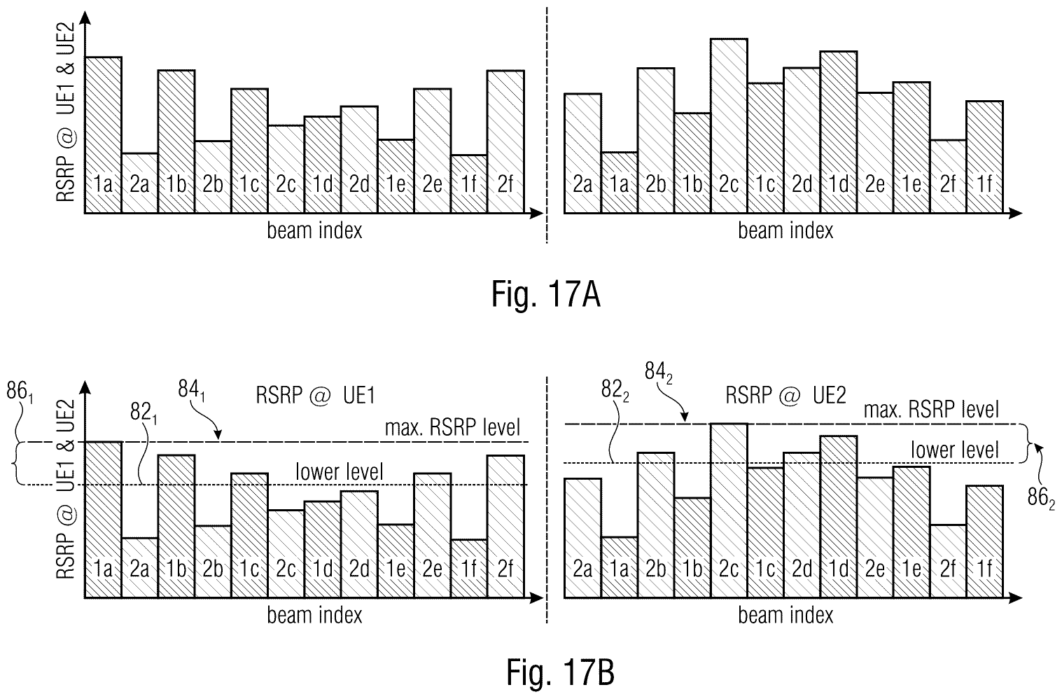

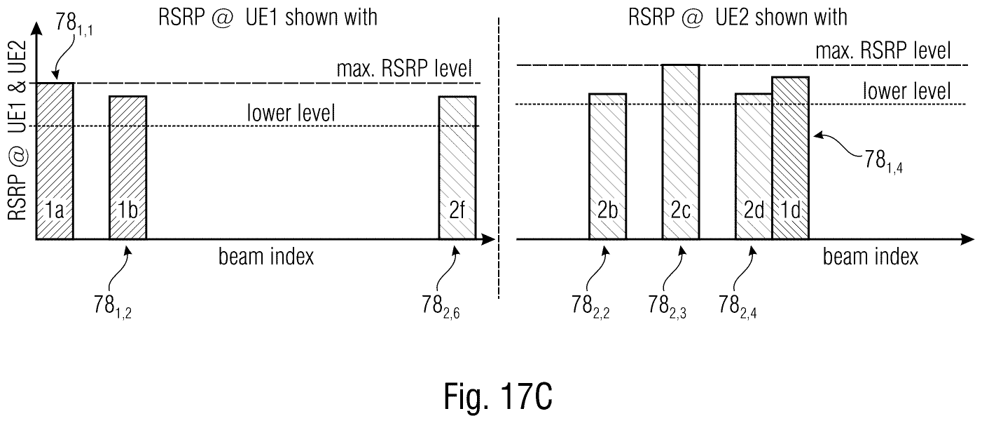

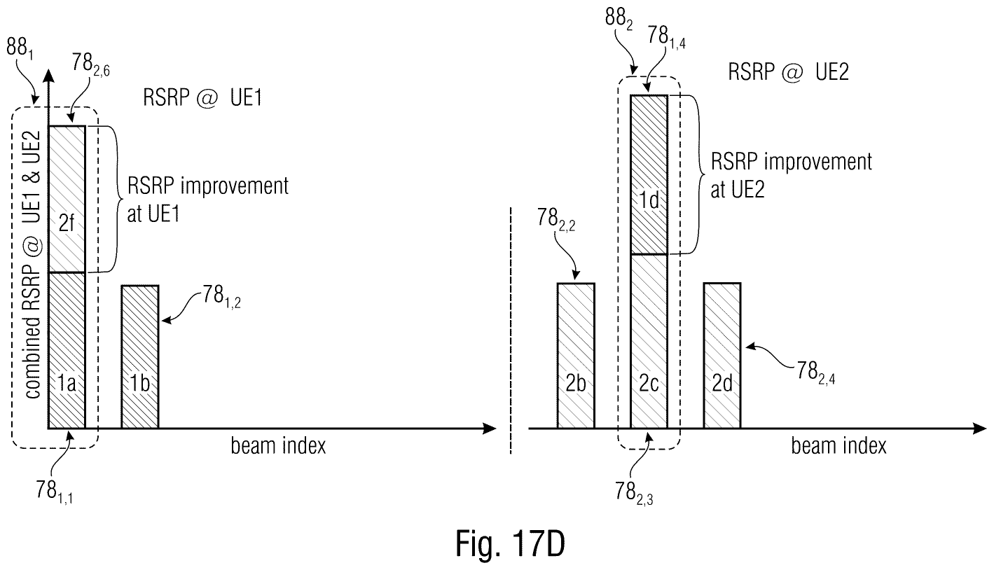

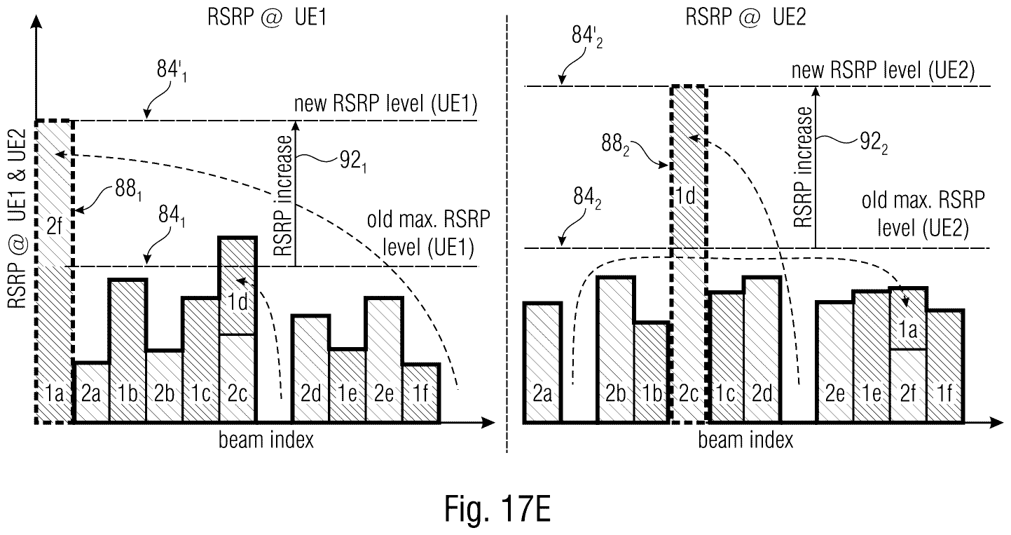

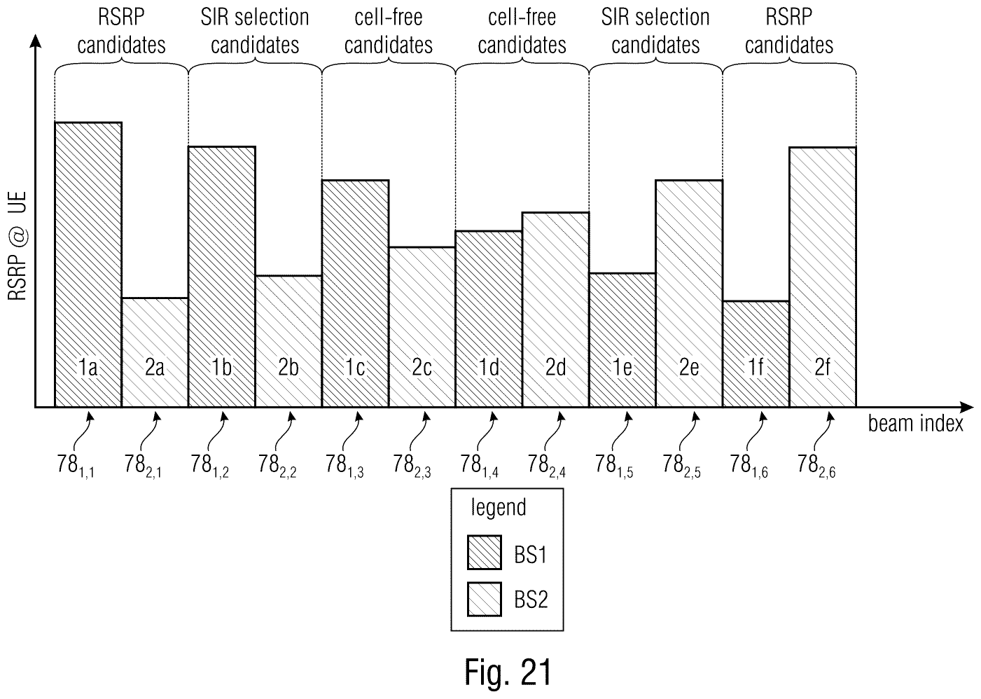

A UE according to an embodiment may be adapted to receive information indicating preselected TRPs, e.g., by an assistance information message, AIM, and/or via sidelink, SL, and to generate the list of TRPs from the preselected TRPs. For example, the UE may receive a list of TRPs from which the UE may select a subsection to be reported as suitable candidates. For a specific purpose, see, e.g., FIG. 17a-e and/or FIG. 21.

A UE according to an embodiment may be adapted to indicate one or more suitable TRPs using an index of spatial resources used by the one or more TRPs.

A UE according to an embodiment may be configured or configurable to receive information, e.g., by decoding a master information block, MIB, or a system information block, SIB, indicating how many TRPs are using a specific cell-ID, reference signals, RSs, or other specific identifiers associated with the joint resources e.g. jointly used REs and/or RSs.

A UE according to an embodiment may be configured or configurable to receive and decode an information block such as a master information block, MIB or system information block, SIB, comprising an identifier indicating a combination or collaboration of TRPs and/or a combination or collaboration of beams coming from different TRPs.

A UE according to an embodiment may be configured or configurable to receive and decode a signal indicating an operation mode of a set of operation modes implemented by the wireless communication network, the set of operation modes related to different types of use of the same resources with different TRPs.

### UE Assisted Network Configuration

In the following there is provided an example of network configuration and TRP collaboration area selection exploiting UE CSI feedback assistance for multi-TRP selection for cell-free operation:

Consider two UEs UE1 and UE2 within a coverage overlap of two base stations BS1 and BS2, to be configured to measure and report feedback about RSRP of beams transmitted from the base stations.

In a realistic communication scenario the UEs are connected to the network in different states such as RRC states of operation, usually referred to as active, idle, inactive, wherein the UEs are providing CSI and connectivity feedback on a regular basis which is configurable. This allows the network to keep track of the latest connectivity option a particular UE has and register this location in a location repository. This allows the network to page the UE for updates of the connectivity location and or to wake up for incoming calls.

To provide the required channel feedback the UEs involved (UE1 and UE2) will be configured by the network to follow a feedback procedure as describe in the following sections. The CSI feedback procedure according to embodiments may follow the following rationale:

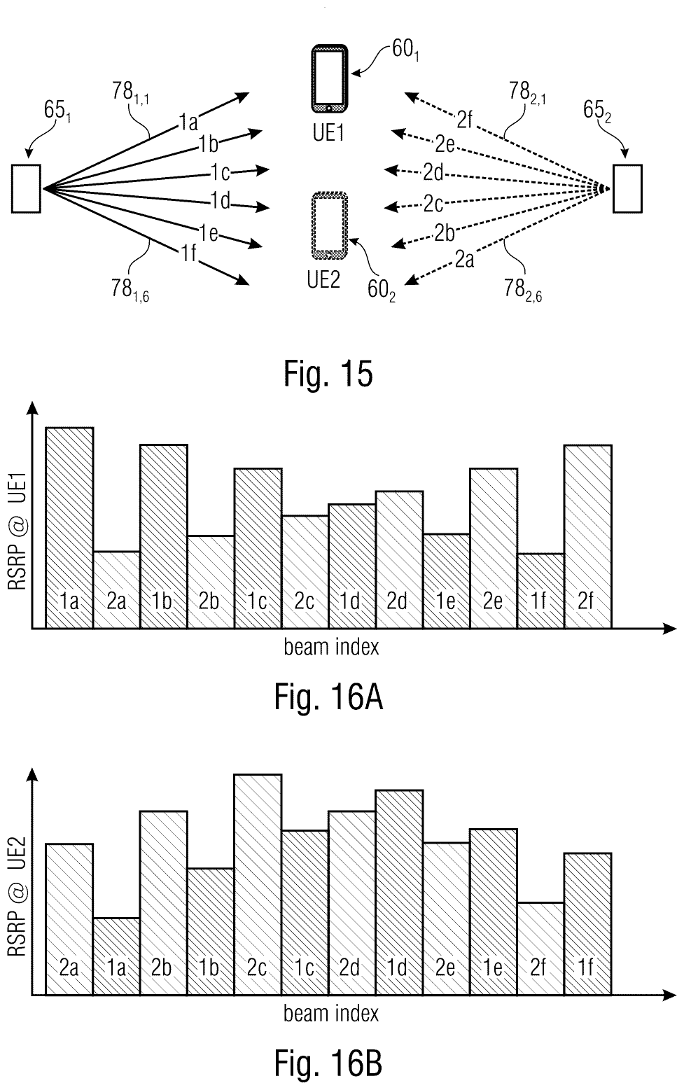

Reference is made to FIG. 15 showing an example scenario in connection with embodiments described herein where UEs 60₁ and 60₂ are located within the coverage of base stations 65₁ and 65₂ providing beams 78_{1,1} to 78_{1,6} and beams 78_{2,1} to 78_{2,6} respectively. In one example, UE 60₁ may remain in a previous or unchanged position whereas UE 60₂ may be moved towards the center of the beam fans.

### Measurement of Beams From Multi-TRP at the UE

The following procedure may be implemented in parts or completely with devices described herein. FIG. 16a shows a schematic illustrative example of beam measurements that may be made with UE 60₁ of FIG. 15. FIG. 16b shows a corresponding result of measurement results according to the illustrative example that may be obtained by UE 60₂. FIGS. 16a and 16b provide for measurement results that relate, for example, to RSRP. Different cross-hatchings in FIGS. 16a and 16b indicate the device performing the measurements for later explanations.

In FIG. 16a, the RSRP of UE 1 that is measured on the static or repeatedly broadcasted beams from base stations 65₁ and 65₂ is more or less constant due to the fixed position of UE 60₁. To visually reinforce the observation of RSRP associated with UE 1, cross-hatching with a +45° slope is used (//).

In FIG. 16b, whereas the RSRP experienced by UE 2 may change over time depending on its changing location relative to BS 65₁ and BS 65₂, the measured RSRP plotted in FIG. 16b may represent the location of UE 60₂ in FIG. 15 and may be different to what UE 60₁ experiences due to a significant difference in location. Such differences can now be exploited for the TRP and beam collaboration according to embodiments to support the reporting UEs such that their effective channels after activating a matching TRP collaboration mode will be improved substantially. To visually reinforce the observation of RSRP associated with UE 60₂ cross-hatching with a −45° slope is used (\\).

That is, in a first step, each UE may measure RSRP values associated to beams formed by base stations 65₁ and 65₂ and possibly other base stations.

### Identification of TRP and Beam Candidates at the UE

In a step 2 each UE may apply a configured beam signal strength selection window, wherein such a configuration may be provided or set by a base station, a central coordinating unit, the UE or may be set a priori.

FIG. 17a shows a combination of FIGS. 16a and 16b, i.e., the two RSRP observation samples are now shown together without confusion due to the use of the cross-hatching. This may correspond to the complete CSI based on RSRP and may grow quadratically with the number of TRPs and UEs involved. Therefore, means to reduce the amount of information before sending feedback may be useful.

### Selection of CSI Candidates at the UE for Feedback Reduction

In a step 3.1, each UE may apply a configured selection window to reduce the reported set of beams to a reasonable number of beams, e.g., to perform feedback overhead reduction. In FIG. 17b, there is shown a lower power level 82₁ and 82₂ implemented by UE 60₁, 60₂ respectively with regard to a maximum power level 84₁, 84₂ respectively, thereby providing for a relative selection window. To use absolute power levels is possible without limitation as well as any combination thereof.

In FIG. 17b, for each UE, the RSRP associated with each beam index is measured, thus allowing the maximum RSRP level to be determined, e.g., drawn as the line 84₁, 84₂ respectively labeled as “max. RSRP level”. With reference to the maximum, a lower level is drawn as lines 82₁ and 82₂ which thus defines a selection window.

FIG. 17c shows remaining beams selected by UE 60₁, 60₂ respectively and based on the selection windows 86₁ and 86₂ of FIG. 17b. It has to be noted that the selection windows 86₁ and 86₂ may be identical between different UEs but may also differ from one another, e.g., based on different capabilities of the UEs such as a remaining battery lifetime, maximum transmitted power or quality of service requirements or the like.

In FIG. 17c, after application of the selection windows 86₁ and 86₂, the beam candidates for a CSI feedback report may be further reduced to the beams meaningful in transferring sufficient power from base stations 65₁ and 65₂ to the UEs 60₁ and 60₂. In this example, the number of beams within the selection window to be reported per base station may be limited to one or another predefined number. UE 1 may report beam 1a, i.e., beam 78_{1,1} from BS 65₁ and beam 78_{2,6} from base station 65₂ while UE 60₂ may report beam 78_{1,4} from base station 65₁ and beam 78_{2,3} from base station 65₂.

### Base Station Coordination Based on Provided CSI Feedback From UEs

Step 4: The two base stations 65₁ and 65₂ may now coordinate beams among each other and define joint beam sets based on the provided feedback from the UEs. These sets of joint beams may create a set of new beams observable at the UEs, significantly increasing the SIR between the new serving set of beams and beams belonging to another set of beams. As a result each UE 60₁ and 60₂ may experience an SINR improvement similar as if it would be in the hotspot (cell centre) of a beams coming from a cell tower.

It may be important to stress that the concept creates beam sets comprised of beams (beam subspaces) from different TRPs and thus does not operate on all resources (time, frequency, space, code) used by the wireless communication network, WCN. These beam sets can thus be considered as joint beams even though they are transmitted from different TRPs. Furthermore, the beam sets can be configured to use e.g. identical pilots (CSI-RS, DMRS) and to carry same or different data on PDCCH or PDSCH on particular resources.

FIG. 17d shows RSRP improvement that may be obtained at UE 60₁ (UE 1), 60₂ (UE 2) respectively. The new effective channels created by collaboration of base stations 65₁ and 65₂ may be considered as new beams consisting of a combination of the former beams 78_{1,1} (1a) from base station 65₁ and beam 78_{2,6} (2f) from base station 65₂ now belonging to a joined set 88₁, while the combination of beams 78_{1,4} from base station 65₁ and beam 78_{2,3} from base station 65₂ may form a new joint set 88₂. To keep such joint sets 88₁ and 88₂ identifiable for the UEs, they may use collaborated transmitted pilots (RS) and data. This can be done in a non-coherent fashion (non-coherent BS collaboration) and/or in a coherent fashion (coherent BS collaboration). The latter is not to be mistaken with coherent CoMP (coordinated multipoint) wherein the UE feedback contains details on phase and amplitudes and therefore requires a very high amount of feedback.

Such a selection about the specific TRP to be used for providing service to the UE and about the beams may be done at the network side such as a BS or a different control unit. According to an embodiment, the wireless communication network comprises a control unit configured for selecting a subset from available TRPs in the wireless communication network, the subset including the first TRP and the second TRP; wherein the control unit is configured for selecting the subset based on connectivity information associated to a connectivity of the UE to the available TRPs and/or associated with a position of the UE. Such connectivity information may be received, directly or indirectly with a base station and further processes.

The connectivity information may comprises spatial domain related information. Such spatial domain related information is not limited to at least one of:
one or more antennas of the UE and/or TRP,
used TX and/or RX beamformers, wherein the beamformers can be analogue beamformers, digital beamformers or combinations thereof, aka hybrid beamformers.
a transmit antenna port of the TRP/BS,
a receive antenna port of the UE
a physical or logical antenna port, wherein
   the individual antenna ports are associated with a single TRP or multiple TRPs
   the individual antenna ports are associated with a single antenna panel or multiple antenna panels
an antenna panel,
panel numbers,
an antenna location,
an antenna radiation direction,
a quasi colocation, QCL, information,
a preferred matrix indicator, PMI,
a sorted or unsorted list of:
   preferred beams, antenna ports in selection or combination,
   beams, antenna ports to be avoided in combination,
   combination of preferred beams and beams to be avoided in when selected individually, in sequence or in simultaneous combination,
a set of beams, antenna ports and associated PMI, e.g., comprising codebook or port selection entries, phase and/or amplitude information for linear combinations of a selected subset of beams, antenna ports,
a mode of transmission or reception to be maintained in single TRP or multi-TRP mode,.
a mode of transmission or reception to be changed from single-TRP to multi-TRP mode or from multi-TRP to single-TRP mode,
a mode of transmission or reception to be changed from a first multi-TRP mode to a second multi-TRP mode or from a second multi-TRP to a first multi-TRP mode, and/or.
the mode of single or multi-TRP operation can be signalled by a multiplicity of joint or pairs of DL/UL TCI states, wherein these states can be configured and activated

Alternatively or in addition, the connectivity information may comprise a frequency domain related information. Such frequency domain related information is not limited to:
a transmission band and/or a reception band,
a transmission sub-band and/or a reception sub-band, and/or
an antenna port quasi co-location configured, activated or reported, e.g., using pairs or joint TCI states referring to component carriers, CC, and/or downlink, DL, bandwidthparts, BWPs.

Alternatively or in addition, the connectivity information may comprise a time domain related information. Such time domain related information is not limited to:
a frame,
a slot, a downlink slot, an uplink slot, a flexible slot and/or a subslots, and/or
a downlink symbol, an uplink symbol and/or a flexible symbol.

According to an embodiment, the device may thus indicate or even request to switch between different TRP modes, including but not limited to select the participants of a multi-TRP mode or a single-TRP mode but also to switch from a single-TRP mode to a different single-TRP mode, to switch from a first multi-TRP mode to a different multi-TRP-mode and/or to switch from a single-TRP mode to a multi-TRP mode or vice versa. For example, when operating in a multi-TRP mode and the device recognizes by way of the measurement results that a second beam does not provide for significant advantage in combination with the first beam, it may request to return to a single-TRP mode again or vice versa.

According to an embodiment, the control unit is configured to obtain the connectivity information from reports transmitted by at least one UE operating in the wireless communication network.

According to an embodiment, the wireless communication network comprises a control unit configured for selecting a subset from available TRPs in the wireless communication network to serve the UE, the subset including at least the first TRP and the second TRP; wherein the control unit is configured for selecting the subset based on a capability of the UE to decode a number of received signals during a same instance of time.

The concept may be applied to groups of UEs instead of a single UE without severe modifications, especially for quasi-collocated or adjacent UEs. According to an embodiment, the UE may be a member of a group of UEs, wherein the wireless communication network is configured for controlling the first TRP and the second TRP for jointly serving the group of UEs.

According to an embodiment, the first TRP and the second TRP are members of a group of TRPs having at least a third TRP.

The given example illustrates evidently that a significant SINR improvement can be achieved by applying the proposed schemes therefore enabling the network to create flexible and dynamic cell patterns wherein the selection of suitable beam-collaboration patterns follows the user distribution, their SINR requirements and the overall available radio resources in time, frequency and space.

This is further illustrated in FIG. 17e. Therein, it is shown that for UE 60₁ an increase 92₁ of former maximum RSRP level 84₁ towards new RSRP level 84′₁ is obtained by set 88₁ and that for UE 60₂ set 88₂ provides for an increase 92₂ from former maximum RSRP power 84₂ to new RSRP maximum power 84′₂.

In FIG. 17e, the “wanted” joint TRP beam pairs are shown within the sets 88₁ and 88₂ whereas the interfering joint TRP beam pairs together with all remaining independent TRP beams are the remaining beams or sets.

A UE according to an embodiment may be configured to measure a quality parameter such as reference signal received power, RSRP, for a plurality of beams of at least two TRPs, see step 1. The UE may select a subset of the plurality of beams according to a selection criteria, e.g., using a predefined window, a minimum power, a maximum power, a predefined number or the like to obtain a selected subset, see steps 3.1 and 3.2; and may report, to the wireless communication network, the selected subset as a set of suitable candidates for providing the first signal and the second signal.

### Exploitation of Provided CSI Feedback over a Larger Set of Base Stations

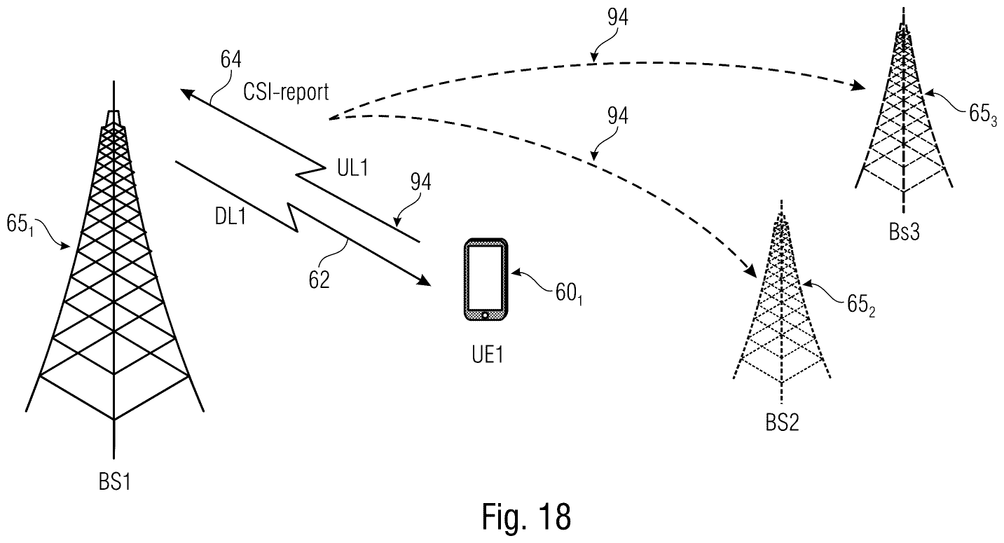

With reference to FIG. 18, a report 94 such as a CSI-report sent from UE 60₁ to BS 65₁ may also be received by other base stations, such as BS 65₂ and 65₃, that may make use of the information contained therein.

For example, the report sent from UE 60₁ to BS 65₁ can also be received and decoded by at least one other BS 65₂ and/or 65₃. In addition, 65₂ and 65₃ may observe at least partially the communication between UE 60₁ and BS 65₁ based on at least one of: reference signals (RSs) directly; control plane data and/or user plane data which can be used to measure or estimate the CSI between UE 60₁ and BS 65₂ and between UE 60₁ and BS 65₃; a position of one or more partners; and/or the used or selected beams (SRS).

By decoding the report 94, both BS 65₂ and BS 65₃ may obtain information about the link between BS 65₁ and UE 60₁, about its stability and/or changes, for example, those which can be deduced from MIMO-feedback for the downlink.

BS 65₂ and/or BS 65₃ may provide feedback of the channel between UE 60₁ and BS 65₂/BS 65₃ to BS 65₁ and/or to other network entities relating to their: observations, measurements or estimations; planned or requested actions; and impact or effect on other links. This thus provides a mechanism for link coordination/cooperation/collaboration.

Reports 94 can be stored together with the position/location of the UE that reported the CSI report, e.g., for further evaluation and/or machine learning to further optimise the network. For example, an autonomous guided vehicle (AGV) moves along a known trajectory and can predict CSI based on stored CSI-reports. Alternatively or in addition, for example, reports 94 can be used instead of GPS information to determine location indoors. A UE according to an embodiment may be adapted to access information of the wireless communication network indicating CSI reports together with an associated position and to use the CSI report and the position for a prediction of a future channel state.

### Group Encryption or Uplink Multicast

Known concepts require encryption of CSI-reports between the UE and the serving BS therefore making it difficult for other BS to read the UE feedback message directly over the air. Usually, the serving BS decodes the message and forwards its content plus further context to other BSs.

According to an embodiment, a joint-link encryption, wherein the encryption keys are shared among the BSs which should decode the UE feedback messages independently and in parallel, is provided.

This mechanism allows the UE to send encrypted messages to a plurality of other network entities wherein the group of permitted recipients is configurable by the network, the UE or another entity.

### UE-centric Network Coverage Monitoring and Flexible Configuration of the Network

In order to assure scalability for larger sets of UEs and base stations the base stations can exchange received channel feedback from UEs served by the individual BS to increase the potential collaboration range between BSs beyond the range of reliably detecting and decoding CSI report messages of UEs meant for other BSs. This is in particular of benefit if far away BSs cause significant interference which according to known concepts is either not reliably identified by UEs or not suitably considered in beam management and or scheduling at the BS causing the interference.

In the proposed concept the UEs are considered to measure the wireless channels in the downlink based on RS associated with individual base stations, sectors, beams or collaboration sets thereof.

The identifiers to estimate, monitor and evaluate the downlink channel are provided to the UEs via configurations either by the network of implicitly by a priori knowledge e.g. according to a standard and/or a database (almanac).

To enable UE-centric joint TRP configuration in the network and operation thereof, embodiments provide the following options:
Option A—identification of each BS (possibly needed for the initiation of RRC connected state and/or legacy devices); and
Option B—identification of BS sets and the resources used within the set.

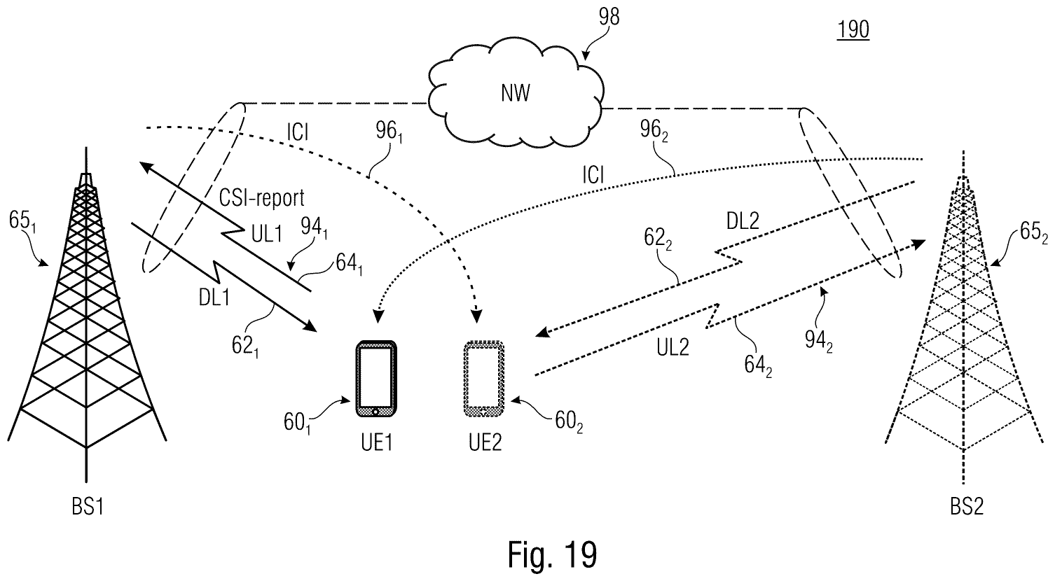

In FIG. 19 there is shown a schematic representation of a wireless communication network 190 according to an embodiment illustrating the concept that based on reports 94₁ and/or 94₂, e.g., CSI reports provided by UEs 60₁ and 60₂ to their respective base stations 65₁, 65₂ respectively, there may be obtained overall knowledge about inter-cell interference ICI 96₁, 96₂ respectively, e.g., by use of a central instance 98 of the wireless communication network 190 or via exchange of information between base stations 65₁ and 65₂.

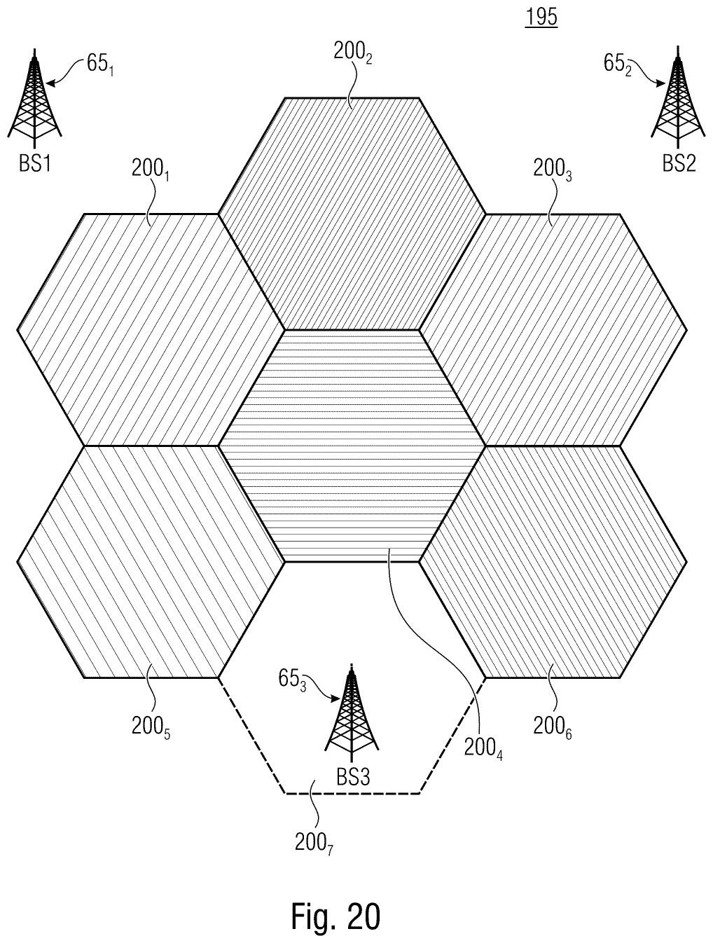

FIG. 20 shows a schematic representation of a wireless communication network 195, wherein the BS-set, comprised here of base stations 65₁, 65₂ and 65₃, is shown in connection with different coverage areas 200₁ to 200₇, thereby identifying sets of resources that may be made available for collaborative purposes. Such a reuse may include, for example, a joint (re-)use of antenna ports (or SSBs used at the antenna port numbers).

Provided that a UE may identify and differentiate between different TRPs and resources, e.g., beams or the layers used by the TRPs, the individual UEs may classify certain channels and/or combinations thereof to be suitable for specific types of operation. Such types of operation may include but are not limited to:
1. Channel identification and selection according to RSRP as a suitable metric;
2. Channel identification and selection in a cross-wise relation according to SIR as a suitable metric; and/or
3. Channel identification and selection for cell-free operation wherein the achievable effective channel gain depends on the mode of collaboration finally applied by the network.

In FIG. 21 there is provided an example of a measurement at a UE based on RSRP values identifying beams from two base stations. Again, the number of base stations used for such measurements and/or reports are not limited to two but may include a different and in particular higher number. The selection of certain beam combinations may be understood more for illustration purposes and is not according to a specific selection algorithm. It should rather illustrate that certain measured channels can be selected and reported to assist the network in multi-TRP cooperation to achieve an improvement in the effective channel observed by the UE when applying the one of other cooperation modes. In other words, as shown in FIG. 21, known candidates for RSRP may support independent TRP cooperation. New candidates are identified as SIR selection and candidates for cell-free operations may enable and require joint TRP transmission/reception.

With regard to the concept of multi-TRP usage/enablement, a UE according to an embodiment may be adapted to report to the wireless communication network; wherein the UE is to include into the report information indicating a measured channel between the UE and individual TRPs and/or a measured channel between the UE and at least one collaborative set of TRPs, wherein the measurements are done simultaneously or sequentially, e.g., on temporal, spectral or spatial resources.

A UE according to an embodiment may be configured for receiving resource information indicating resources used by a collaborative set of TRPs and/or resources used by a non-collaborative multi-TRP, e.g., providing one signal from one TRP only; wherein the UE is adapted to select a signal to be decoded based on the resource information.

With regard to the collaboration, in a non-collaborative multi-TRP mode, e.g., in single or in dual connectivity, a handover between BSs is known. Such a procedure may be avoided, at least for participating devices when applying suitable beams at the base stations or TRPs, e.g., based on the reports. However, it should be noted, that the embodiments are also applicable in connection with devices that cannot decode multiple signals such as the two or more signals described herein that may be decoded by a UE. According to an embodiment, a UE that may not benefit from the cell-free approach may operate in a wireless communication network that utilizes resources of a time/frequency grid; and may be adapted to report to the wireless communication network about a lack of capability indicating that the UE is incapable of processing, a first signal received from a first transmission/reception point, TRP, and a second signal received from a second TRP, the first signal and the second signal occupying resources in the same time/frequency grid and received during a same instance of time. This may allow, for example, to avoid calculations and TRP synchronisation for such devices that might be subjected to the cell-free approach, e.g., based on a position-based machine learning that identifies a set 88 described herein based on a position of the UE.

A UE according to an embodiment may be adapted to receive and decode the first signal and the second signal; wherein the UE is to provide a mode information to the wireless communication network, the mode information to indicate that the UE is capable to operate in a collaborative multi-TRP mode or is capable to operate in a non-collaborative multi-TRP mode, e.g., using a Uu interface towards the wireless communication network and/or using a sidelink interface such as PC5 to other UEs.

A UE according to an embodiment may be adapted to obtain handover related information, the handover related information indicating the availability of collaborative and optionally indicating at least one of non-collaborative multi-TRP operation in the network and/or further information, e.g. related RS, cell identifiers, neighbourhood lists and barred/restricted cells.

A UE according to an embodiment may be configured to request a handover from a first cell operated in non-collaborative multi-TRP mode to a second cell operated in collaborative multi-TRP mode or vice versa.

A UE according to an embodiment may measure, e.g., individually, wireless channels based on reference signals, RS, associated to different base stations, sectors, beams and/or collaboration sets thereof and to provide a report to the wireless communication network indicating a result of the measuring. For example, the UE may individually measure wireless channels. By way of an optional implementation, the UE may individually report about the wireless channels instead of a common report.

A network comprising at least one UE described herein may benefit in a plurality of ways. A wireless communication network according to an embodiment comprises a user equipment, UE, described herein; a set of transmission/reception points, TRPs, including the first TRP and the second TRP, each TRP adapted to provide a signal in the wireless communication network to collaboratively transmit signals to the UE. The wireless communication network is configured for controlling the first TRP and the second TRP.

According to an embodiment, the wireless communication network is configured to control different TRPs and/or BSs to utilise a subset of resources available for the TRP or BS for a collaboration where the subset is used as the same resources by different TRPs.

According to an embodiment, the wireless communication network is adapted to receive, e.g., from a UE or a different node a capability signal comprising information indicating a set of TRPs that are suitable for the UE and to provide a simultaneous first connectivity and a second connectivity by use of at least one TRP from the set of TRPs

According to an embodiment, the wireless communication network comprises a set of TRPs, wherein the wireless communication network is to repeatedly control a subset of the TRPs to collaboratively transmit signals to the UE using same resources; wherein the wireless communication network is to select and/or reselect the subset of collaborative TRPs based on a channel state experienced by the UE and/or a position of the UE.

According to an embodiment, a base station, BS, of the network comprises at least one of the TRPs is to receive a report from the user equipment, UE, indicating a set of beams of different transmission/reception points, TRPs, suitable for the UE for collaborative communication; and to inform at least a different BS about the set of beams.

According to an embodiment, the wireless communication network is adapted to report, to the UE, information indicating TRPs available for a joint operation, e.g., after UE has transmitted a capability signal that it supports such operation or that and/or if a selected subset of TRPs improves an effective communication channel for the UE.

According to an embodiment, a base station, BS, of the network comprising at least one of the TRPs is to receive information provided by a different BS indicating a set of beams of different transmission/reception points, TRPs, suitable for a UE for communication; and to collaborate with the different BS to commonly provide at least a part of the set of beams.

According to an embodiment, the wireless communication network is configured to store a CSI report of a UE together with an associated position of the UE and to use the CSI report and the position of the UE for a collaboration of different UEs.

According to an embodiment, the wireless communication network is configured to provide an encryption key for a specific UE to different base stations, BS; wherein the different BS are to decode an encrypted message of the UE independently and in parallel using the encryption key.

According to an embodiment, the wireless communication network is configured to receive information indicating a selected subset of beams that indicate candidates of different TRPs suitable for providing a fist signal and a second signal for the UE; and to coordinate beams of at least two TRPs to provide a joint beamset based on the selected subset.

According to an embodiment, the wireless communication network is configured to control the different TRPs to use identical pilots such as Channel State Information Reference Signals, CSI-RS, and/or Demodulation Reference Signals, DMRS; and/or to carry same or different data on Physical Downlink Control Channel, PDCCH, or Physical Downlink Shared Channel, PDSCH on particular resources.

According to an embodiment, the wireless communication network is configured to receive the report from the UE with a set of at least two base stations independently or in a hierarchical manner.

Embodiments relate not only to UEs and to networks but also to base stations that allow to participate in the described cell-free approach. A base station such as base station 65 may be configured to operate in a wireless communication network to provide communication to a user equipment, UE. The base station is adapted to receive a report from a member of the wireless communication network, e.g., directly form the UE or indirectly via another BS, see FIGS. 18 and 19, the report indicating a set of beams of different transmission/reception points, TRPs, suitable for the UE for communication; and to inform at least a different base station about the set of beams; or the base station adapted to receive a report from a member of the wireless communication network indicating at least one beam to be excluded for a multi-TRP operation for the UE; and to operate accordingly. Other BS can be informed by the BS receiving the reports from UE OR by any other suitable entity which has information contained in the report. Furthermore, several BSs can receive the report independently or in a hierarchical manner.

According to an embodiment, a base station is configured for selecting a subset from available TRPs in the wireless communication network based on a report provided by the UE, the subset including the first TRP and the second TRP; wherein the base station is configured for selecting at least a part of the subset based on connectivity information associated to a connectivity of the UE to the available TRPs and/or associated with a position of the UE. For example, the base station selects only one of its own TRP, at least a second available TRP or a set not including an own TRP.

According to an embodiment, a base station is configured to obtain the connectivity information from reports transmitted by at least one UE operating in the wireless communication network.

According to an embodiment, a base station is configured for predicting a future position of the UE based on the report and to operate as part of a set of collaborating base stations serving the UE based on the future position.

According to an embodiment, a base station is adapted for verifying the set of beams and/or the different TRPs whether they are suitable for serving the UE and for controlling the TRPs to provide the communication if the different TRPs are determined to be suitable. For such determination, a criterion may be applied such as RSRP increase, a parameter associated therewith or other considerations, including availability, throughput or quality needs of one, more or the overall set of devices participating in the communication.

According to an independent aspect relating to a base station, a base station configured to operate in a wireless communication network, is adapted to receive an information, e.g., from another base station, relating to at least a subset of a set of beams; and to control a transmission/reception point TRP to form a beam from the subset according to the information, e.g., to provide a signal to a device. That is, the base station may receive a command or request from another entity, e.g., another BS, a central entity or a UE, and may operate accordingly, e.g., when not being aware of contradicting information or commands.

According to an embodiment, such as base station of claim may be configured for controlling the TRP to operate jointly with a TRP not controlled by the base station. For example, the BS may provide the required information to another BS

According to an embodiment, a method for operating a device such as a user equipment, UE, for operating in a wireless communication network that utilizes resources of a time/frequency grid is provided, the method comprising: reporting, with the device, to the wireless communication network a connectivity information associated to a first connectivity option of the device to the wireless communication network and associated to a second connectivity option of the device to the wireless communication network; and/or receiving, with the device and during a same instance of time, and decoding a first signal received from a first transmission/reception point, TRP, and a second signal from a second TRP, the first signal and the second signal occupying resources in the same time/frequency grid.

According to an embodiment, such a method of comprises: measuring a quality parameter such as reference signal received power, RSRP, for a plurality of beams of at least two TRPs; selecting a subset of the plurality of beams according to a selection criteria to obtain a selected subset; and reporting, to the wireless communication network, the selected subset as suitable candidates for providing the first signal and the second signal.

According to an embodiment, a method for operating a wireless communication network is provided, the method comprising: operating a user equipment, UE; operating a set of transmission/reception points, TRPs, including a first TRP and a second TRP, each TRP adapted to provide a signal in the wireless communication network to collaboratively transmit signals to the UE; such that the wireless communication network controls the first TRP and the second TRP.

According to an embodiment, a method for operating a base station to provide communication to a user equipment, UE, in a wireless communication network is provided, the method comprising:
receiving and decoding a report from a member of the wireless communication network, indicating a set of beams of different transmission/reception points, TRPs, suitable for the UE for communication; and informing at least a different base station about the set of beams; or receiving a report from a member of the wireless communication network indicating at least one beam to be excluded for a multi-TRP operation for the UE; and operating the base station accordingly.

According to an embodiment, a method for operating a base station in a wireless communication network is provided, the method comprising: receiving an information relating to at least a subset of a set of beams; and controlling a transmission/reception point TRP to form a beam of the subset according to the information.

Embodiments offer the following benefits:
1. Resilience against blockage at higher frequencies due to macro diversity provided by BSs received from different direction.
2. Intra-joint-beam-set “handover” since loss/blockage of one BS of the joint set still keeps the UE connected within the joint set.
3. If coherence at higher carrier frequencies, e.g. mmW or sub-THz, is more difficult due to phase noise, then coherent cell-free becomes difficult if not infeasible. Non-coherent operation is therefore proposed as this is still feasible.

Embodiments may also use RIS and repeaters. For example, a joint set of beams may include active propagation environment elements such as RIS or NCR, which may become part of the measurement, feedback and configuration procedure.

In an embodiment, a computer readable digital storage medium has stored therein a computer program having a program code for performing, when running on a computer, a method described herein.

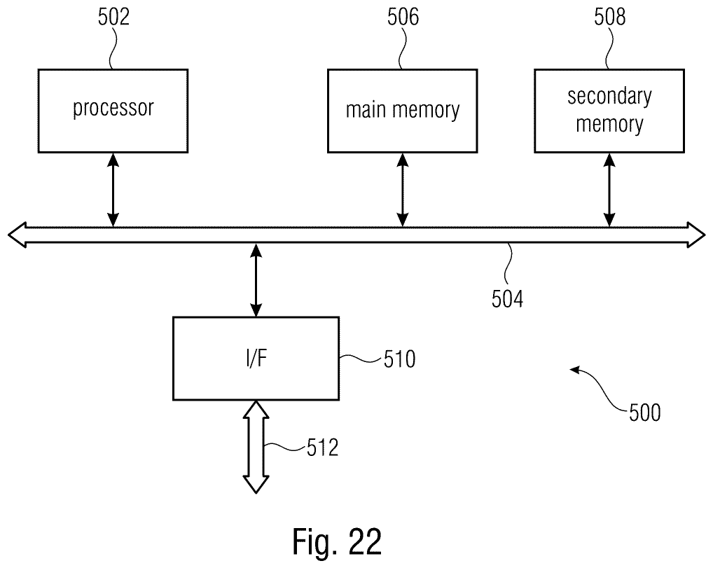

Various elements and features of the present invention may be implemented in hardware using analogue and/or digital circuits, in software, through the execution of instructions by one or more general purpose or special-purpose processors, or as a combination of hardware and software. For example, embodiments of the present invention may be implemented in the environment of a computer system or another processing system. FIG. 22 illustrates an example of a computer system 500. The units or modules as well as the steps of the methods performed by these units may execute on one or more computer systems 500. The computer system 500 includes one or more processors 502, like a special purpose or a general-purpose digital signal processor. The processor 502 is connected to a communication infrastructure 504, like a bus or a network. The computer system 500 includes a main memory 506, e.g., a random-access memory (RAM), and a secondary memory 508, e.g., a hard disk drive and/or a removable storage drive. The secondary memory 508 may allow computer programs or other instructions to be loaded into the computer system 500. The computer system 500 may further include a communications interface 510 to allow software and data to be transferred between computer system 500 and external devices. The communication may be in the form of electronic, electromagnetic, optical, or other signals capable of being handled by a communications interface. The communication may use a wire or a cable, fibre optics, a phone line, a cellular phone link, an RF link and other communications channels 512.

The terms “computer program medium” and “computer readable medium” are used to generally refer to tangible storage media such as removable storage units or a hard disk installed in a hard disk drive. These computer program products are means for providing software to the computer system 500. The computer programs, also referred to as computer control logic, are stored in main memory 506 and/or secondary memory 508. Computer programs may also be received via the communications interface 510. The computer program, when executed, enables the computer system 500 to implement the present invention. In particular, the computer program, when executed, enables processor 502 to implement the processes of the present invention, such as any of the methods described herein. Accordingly, such a computer program may represent a controller of the computer system 500. Where the disclosure is implemented using software, the software may be stored in a computer program product and loaded into computer system 500 using a removable storage drive, an interface, like communications interface 510.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are preferably performed by any hardware apparatus.

Additional embodiments of the invention are summarized below:

A UE according to embodiments described herein, wherein the connectivity information comprises frequency domain related information not limited to:
a transmission band and/or a reception band
a transmission sub-band and/or a reception sub-band
an antenna port quasi co-location configured, activated or reported, e.g., using pairs or joint TCI states referring to component carriers, CC, and/or downlink, DL, bandwidthparts, BWPs.

The UE, wherein the connectivity information comprises time domain related information not limited to one or more of:
a frame,
a slot, a downlink slot, an uplink slot, a flexible slot and/or a subslots
a downlink symbol, an uplink symbol and/or a flexible symbol.

A wireless communication network comprising: a device, according to embodiment described herein; a set of transmission/reception points, TRPs, including the first TRP and the second TRP, each TRP adapted to provide a signal in the wireless communication network to collaboratively transmit signals to the UE; wherein the wireless communication network is configured for controlling the first TRP and the second TRP.

The wireless communication network, wherein the wireless communication network is configured to control different TRPs and/or BSs to utilise a subset of resources available for the TRP or BS for a collaboration where the subset is used as the same resources by different TRPs, or wherein the wireless communication network is adapted to receive a capability signal comprising information indicating a set of TRPs that are suitable for the UE and to provide a simultaneous first connectivity and a second connectivity by use of at least one TRP from the set of TRPs.

The wireless communication network, comprising a control unit configured for selecting a subset from available TRPs in the wireless communication network, the subset including the first TRP and the second TRP; wherein the control unit is configured for selecting the subset based on connectivity information associated to a connectivity of the UE to the available TRPs and/or associated with a position of the UE.

The wireless communication network, wherein the control unit is configured to obtain the connectivity information from reports transmitted by at least one UE operating in the wireless communication network.

The wireless communication network, comprising a control unit configured for selecting a subset from available TRPs in the wireless communication network to serve the UE, the subset including at least the first TRP and the second TRP; wherein the control unit is configured for selecting the subset based on a capability of the UE to decode a number of received signals during a same instance of time.

The wireless communication network, wherein the UE is a member of a group of UEs, wherein the wireless communication network is configured for controlling the first TRP and the second TRP for jointly serving the group of UEs, or wherein the first TRP and the second TRP are members of a group of TRPs having at least a third TRP.

The wireless communication network, comprising a set of TRPs, wherein the wireless communication network is to repeatedly control a subset of the TRPs to collaboratively transmit signals to the UE using same resources; wherein the wireless communication network is to select and/or reselect the subset of collaborative TRPs based on a channel state experienced by the UE and/or a position of the UE.

The wireless communication network, wherein a base station, BS, comprising at least one of the TRPs is to receive a report from the user equipment, UE, indicating a set of beams of different transmission/reception points, TRPs, suitable for the UE for collaborative communication; and to inform at least a different BS about the set of beams, or wherein the wireless communication network is to report, to the UE, information indicating TRPs available for a joint operation, e.g., after UE has transmitted a capability signal that it supports such operation or that and/or if a selected subset of TRPs improves an effective communication channel for the UE, or wherein a base station, BS, comprising at least one of the TRPs is to receive information provided by a different BS indicating a set of beams of different transmission/reception points, TRPs, suitable for a UE for communication; and to collaborate with the different BS to commonly provide at least a part of the set of beams, or wherein the wireless communication network is to store a CSI report of a UE together with an associated position of the UE and to use the CSI report and the position of the UE for a collaboration of different UEs, or wherein the wireless communication network is to provide an encryption key for a specific UE to different base stations, BS; wherein the different BS are to decode an encrypted message of the UE independently and in parallel using the encryption key or wherein the wireless communication network is to receive information indicating a selected subset of beams that indicate candidates of different TRPs suitable for providing a fist signal and a second signal for the UE; and to coordinate beams of at least two TRPs to provide a joint beamset based on the selected subset.

The wireless communication network, wherein the wireless communication network is to control the different TRPs to use identical pilots such as Channel State Information Reference Signals, CSI-RS, and/or Demodulation Reference Signals, DMRS; and/or to carry same or different data on Physical Downlink Control Channel, PDCCH, or Physical Downlink Shared Channel, PDSCH on particular resources, or wherein the wireless communication network is to receive the report from the UE with a set of at least two base stations independently or in a hierarchical manner.

A base station configured to operate in a wireless communication network to provide communication to a user equipment, UE, the base station adapted to receive a report from a member of the wireless communication network, indicating a set of beams of different transmission/reception points, TRPs, suitable for the UE for communication; and to inform at least a different base station about the set of beams; or the base station adapted to receive a report from a member of the wireless communication network indicating at least one beam to be excluded for a multi-TRP operation for the UE; and to operate accordingly.

The base station, configured for selecting a subset from available TRPs in the wireless communication network based on a report provided by the UE, the subset including the first TRP and the second TRP; wherein the base station is configured for selecting at least a part of the subset based on connectivity information associated to a connectivity of the UE to the available TRPs and/or associated with a position of the UE.

The base station, configured to obtain the connectivity information from reports transmitted by at least one UE operating in the wireless communication network, or wherein the connectivity information comprises spatial domain related information not limited to at least one of:
one or more antennas of the TRP,
beamformers, wherein the beamformers can be analogue beamformers, digital beamformers or combinations thereof, aka hybrid beamformers.
a transmit antenna port of the TRP,
a receive antenna port of the UE
a physical or logical antenna port, wherein
the individual antenna ports are associated with a single TRP or multiple TRPs
the individual antenna ports are associated with a single antenna panel or multiple antenna panels
an antenna panel,
panel numbers,
an antenna location,
an antenna radiation direction,
a quasi colocation, QCL, information,
a preferred matrix indicator, PMI,
a sorted or unsorted list of:
preferred beams, antenna ports in selection or combination
beams, antenna ports to be avoided in combination
combination of preferred beams and beams to be avoided in when selected individually, in sequence or in simultaneous combination
a set of beams, antenna ports and associated PMI, e.g., comprising codebook or port selection entries, phase and/or amplitude information for linear combinations of a selected subset of beams, antenna ports
a mode of transmission or reception to be maintained in single TRP or multi-TRP mode
a mode of transmission or reception to be changed from single-TRP to multi-TRP mode or from multi-TRP to single-TRP mode.
a mode of transmission or reception to be changed from a first multi-TRP mode to a second multi-TRP mode or from a second multi-TRP to a first multi-TRP mode
the mode of single or multi-TRP operation can be signalled by a multiplicity of joint or pairs of DL/UL TCI states, wherein these states can be configured and activated

The base station, wherein the connectivity information comprises frequency domain related information not limited to:
a transmission band and/or a reception band
a transmission sub-band and/or a reception sub-band
an antenna port quasi co-location configured, activated or reported, e.g., using pairs or joint TCI states referring to component carriers, CC, and/or downlink, DL, bandwidthparts, BWPs.

The base station, wherein the connectivity information comprises time domain related information not limited to one or more of:
a frame,
a slot, a downlink slot, an uplink slot, a flexible slot and/or a subslots
a downlink symbol, an uplink symbol and/or a flexible symbol.

The base station of claim 40, wherein the base station is configured for predicting a future position of the UE based on the report and to operate as part of a set of collaborating base stations serving the UE based on the future position, or wherein the base station is adapted for verifying the set of beams and/or the different TRPs whether they are suitable for serving the UE and for controlling the TRPs to provide the communication if the different TRPs are determined to be suitable.

A base station configured to operate in a wireless communication network, the base station adapted to receive an information, e.g., from another base station, relating to at least a subset of a set of beams; and to control a transmission/reception point TRP to form a beam from the subset according to the information, e.g., to provide a signal to a device.

The base station, wherein the base station is configured for controlling the TRP to operate jointly with a TRP not controlled by the base station.

A device such as a user equipment, UE, configured for operating in a wireless communication network that utilizes resources of a time/frequency grid; wherein the UE is adapted to report to the wireless communication network about a lack of capability indicating that the UE is incapable of processing, a first signal received from a first transmission/reception point, TRP, and a second signal received from a second TRP, the first signal and the second signal occupying resources in the same time/frequency grid and received during a same instance of time.

A method for operating a device such as a user equipment, UE, for operating in a wireless communication network that utilizes resources of a time/frequency grid the method comprising: reporting, with the device, to the wireless communication network a connectivity information associated to a first connectivity option of the device to the wireless communication network and associated to a second connectivity option of the device to the wireless communication network; and/or receiving, with the device and during a same instance of time, and decoding a first signal received from a first transmission/reception point, TRP, and a second signal from a second TRP, the first signal and the second signal occupying resources in the same time/frequency grid.

The method further comprising: measuring a quality parameter such as reference signal received power, RSRP, for a plurality of beams of at least two TRPs; selecting a subset of the plurality of beams according to a selection criteria to obtain a selected subset; and reporting, to the wireless communication network, the selected subset as suitable candidates for providing the first signal and the second signal.

A method for operating a wireless communication network, the method comprising: operating a user equipment, UE; operating a set of transmission/reception points, TRPs, including a first TRP and a second TRP, each TRP adapted to provide a signal in the wireless communication network to collaboratively transmit signals to the UE; such that the wireless communication network controls the first TRP and the second TRP.

A method for operating a base station to provide communication to a user equipment, UE, in a wireless communication network, the method comprising: receiving and decoding a report from a member of the wireless communication network, indicating a set of beams of different transmission/reception points, TRPs, suitable for the UE for communication; and informing at least a different base station about the set of beams; or receiving a report from a member of the wireless communication network indicating at least one beam to be excluded for a multi-TRP operation for the UE; and operating the base station accordingly.

A method for operating a base station in a wireless communication network, the method comprising: receiving an information relating to at least a subset of a set of beams; and controlling a transmission/reception point TRP to form a beam of the subset according to the information.

A method for operating a device such as a user equipment, UE, in a wireless communication network that utilizes resources of a time/frequency grid, the method comprising: reporting to the wireless communication network about a lack of capability indicating that the device is incapable of processing a first signal received from a first transmission/reception point, TRP, and a second signal received from a second TRP, the first signal and the second signal occupying resources in the same time/frequency grid and received during a same instance of time.

A non-transitory digital storage medium having a computer program stored thereon to perform the method for operating a device such as a user equipment, UE, for operating in a wireless communication network that utilizes resources of a time/frequency grid the method comprising: reporting, with the device, to the wireless communication network a connectivity information associated to a first connectivity option of the device to the wireless communication network and associated to a second connectivity option of the device to the wireless communication network; and/or receiving, with the device and during a same instance of time, and decoding a first signal received from a first transmission/reception point, TRP, and a second signal from a second TRP, the first signal and the second signal occupying resources in the same time/frequency grid, when said computer program is run by a computer.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

| | | Further |
|---|---|---|
| Abbreviation | Definition | description |
| 2G | second generation | |
| 3G | third generation | |
| 3GPP | third generation partnership project | |
| 3PC | third-party controller | |
| 4G | fourth generation | |
| 5G | fifth generation | |
| 5GC | 5G core network | |
| AAS | active antenna system | |
| AAU | advanced antenna unit | |
| ACLR | adjacent channel leakage ratio | |
| ADC | analogue-to-digital converter | |
| AF | application function | |
| AP | access point | |
| ARQ | automatic repeat request | |
| AU | antenna unit | |
| BER | bit-error rate | |
| BLER | block-error rate | |
| BP | behaviour plane | |
| BS | basestation transceiver | |
| BT | Bluetooth | |
| BTS | basestation transceiver | |
| CA | carrier aggregation | |
| CBR | channel busy ratio | |
| CC | component carrier | |
| CCO | coverage and capacity optimization | |
| CHO | conditional handover | |
| CLI | cross-link interference | |
| CLI-RSS | cross-link interference received signal | |
| | strength | |
| CP | control plane | |
| CP1 | control plane 1 | |
| CP2 | control plane 2 | |
| CPRI | common public radio interface | |
| CSI | channel state information | |
| CSI-IM | CSI interference measurement | |
| CSI-RS | CSI reference signal | |
| CU | central/centralized unit | |
| D2D | device-to-device | |
| DAPS | dual active protocol stack | |
| DAC | digital-to-analogue converter | |
| DC-CA | dual-connectivity carrier aggregation | |
| DECT | digitally enhanced cordless telephony | |
| DL | downlink | |
| DMRS | demodulation reference signal | |
| DOA | direction of arrival | |
| DRB | data radio bearer | |
| DT | digital twin | |
| DU | distributed unit | |
| ECGI | e-UTRAN cell global identifier | |
| E-CID | enhanced cell ID | |
| eCPRI | enhanced CPRI | |
| eNB | evolved Node b | |
| EN-DC | e-UTRAN-New Radio dual connectivity | |
| EUTRA | enhanced UTRA | |
| E-UTRAN | enhanced UTRA network | |
| FSS | frequency-selective surface | |
| gNB | next generation NodeB | |
| GNSS | global navigation satellite system | |
| GPS | global positioning system | |
| GSO | geostationary orbit | |
| HAPS | high-altitude platforms | |
| HARQ | hybrid ARQ | |
| IAB | integrated access and backhaul | |
| ID | identity/identification | |
| IF | intermediate frequency | |
| IIOT | industrial internet of things | |
| KPI | key-performance indicator | |
| LTE | long-term evolution | |
| MCG | master cell group | |
| MCS | modulation coding scheme | |
| MDT | minimization of drive tests | |
| MIB | message information block | |
| MIMO | multiple-input/multiple-output | |
| MLR | measure, log and report | |
| MLRD | MLR device | |
| MNO | mobile network operator | |
| MR-DC | multi-rat dual connectivity | |
| NCGI | new radio cell global identifier | |
| NEF | network exposure function | |
| NG | next generation | |
| ng-eNB | next generation eNB | node providing |
| | | E-UTRA user |
| | | plane and |
| | | control plane |
| | | protocol |
| | | terminations |
| | | towards the UE, |
| | | and connected |
| | | via the NG |
| | | interface to the |
| | | 5GC |
| NG-RAN | either a gNB or an NG-eNB | |
| NGSO | non-geostationary orbit | |
| NIC | network interface connection | |
| NR | new radio | |
| NR-U | NR unlicensed | NR operating in |
| | | unlicensed |
| | | frequency |
| | | spectrum |
| NTN | non-terrestrial network | |
| NZP-CSI-RS | non-zero-power CSI-RS | |
| OAM | operation and maintenance | |
| OEM | original equipment manufacturer | |
| OTT | over-the-top | |
| oRAN | see open RAN | |
| Open RAN | open radio access network | |
| PCI | physical cell identifier | Also known as |
| | | PCID |
| PDCP | packet data convergence protocol | |
| PDCCH | physical downlink control channel | |
| PDSCH | physical downlink shared channel | |
| PER | packet error rate | |
| PHY | physical | |
| PLMN | public land mobile network | |
| PRACH | physical random access channel | |
| PUCCH | physical uplink control channel | |
| PUSCH | physical uplink shared channel | |
| PSBCH | physical sidelink broadcast channel | |
| PSCCH | physical sidelink control channel | |
| PSSCH | physical sidelink shared channel | |
| PSFCH | physical sidelink feedback channel | |
| QCL | quasi colocation | |
| RA | random access | |
| RACH | random access channel | |
| RAN | radio access network | |
| RAT | radio access technology | |
| RF | radio frequency | |
| RIM | radio access network information | |
| | management | |
| RIM-RS | rim reference signal | |
| RIS | reconfigurable intelligent surface | |
| RISC | RIS controller | |
| RLC | radio link control | |
| RLF | radio link failure | |
| RLM | radio link monitoring | |
| RP | reception point | |
| R-PLMN | registered public land mobile network | |
| RRC | radio resource control | |
| RRU | remote radio unit | |
| RS | reference signal | |
| RSRP | reference signal received power | |
| RSRQ | reference signal received quality | |
| RSSI | received signal strength indicator | |
| RSTD | reference signal time difference | |
| RTOA | relative time of arrival | |
| RTT | round trip time | |
| RU | radio unit | |
| SA | standalone | |
| SCEF | service capability exposure function | |
| SCG | secondary cell group | |
| SDU | service data unit | |
| SIB | system information block | |
| SINR | signal-to-interference-plus-noise ratio | |
| SIR | signal-to-interference ratio | |
| SL | side link | |
| SNR | signal-to-noise ratio | |
| SON | self-organising network | |
| SOTA | state-of-the-art | |
| SRS | sounding reference signal | |
| SRI | srs resource indicator | |
| SS | synchronization signal | |
| SSB | synchronization signal block | |
| SSID | service set identifier | |
| SS-PBCH | sounding signal/physical broadcast | |
| | channel | |
| TAC | tracking area code | |
| TB | transmission block | |
| TCI | transmission configuration indication | |
| TDD | time division duplex | |
| TN | terrestrial network | |
| TRD | transmit/receive device | |
| TRP | transmission reference point | |
| TSG | technical specification group | |
| UAV | unmanned airborne vehicle | |
| UE | user equipment | |
| UL | uplink | |
| UP | user plane | |
| URLLC | ultra-reliable low latency | |
| | communication | |
| UTRAN | universal trunked radio access network | |
| V2X | vehicle-to-everything | |
| VoIP | voice over internet protocol | |
| vRAN | virtual ran | |
| WI | work item | |
| WLAN | wireless local area network | |
| ZP-CSI-RS | zero-power CSI-RS | |

1. A user equipment, UE, configured for operating in a wireless communication network that utilizes resources of a time/frequency grid;
wherein the UE is adapted to report to the wireless communication network a connectivity information associated to a first connectivity option of the UE to the wireless communication network and associated to a second connectivity option of the UE to the wireless communication network; and/or
wherein the UE is adapted to receive, during a same instance of time, and decode a first signal received from a first transmission/reception point, TRP, and a second signal received from a second TRP, the first signal and the second signal occupying resources in the same time/frequency grid.

2. The user equipment, UE, of claim 1, wherein the UE is adapted to report to the wireless communication network; wherein the UE is to include into the report information indicating a measured channel between the UE and individual TRPs and/or a measured channel between the UE and at least one collaborative set of TRPs, wherein the measurements are done simultaneously or sequentially.

3. The user equipment, UE, of claim 1, configured for receiving resource information indicating resources used by a collaborative set of TRPs and/or resources used by a non-collaborative multi-TRP; wherein the UE is adapted to select a signal to be decoded based on the resource information.

4. The user equipment, UE, of claim 1, wherein the UE is adapted to receive and decode the first signal and the second signal; wherein the UE is to provide a mode information to the wireless communication network, the mode information to indicate that the UE is capable to operate in a collaborative multi-TRP mode or is capable to operate in a non-collaborative multi-TRP mode, e.g., using a Uu interface towards the wireless communication network and/or using a sidelink interface such as PC5 to other UEs.

5. The user equipment, UE, of claim 1, wherein the UE is to obtain handover related information, the handover related information indicating the availability of collaborative and optionally indicating at least one of non-collaborative multi-TRP operation in the network and/or further information, e.g. related RS, cell identifiers, neighbourhood lists and barred/restricted cells.

6. The user equipment, UE, of claim 1, wherein the UE is configured to request a handover from a first cell operated in non-collaborative multi-TRP mode to a second cell operated in collaborative multi-TRP mode or vice versa.

7. The user equipment, UE, of claim 1, wherein the UE is adapted to report to the wireless communication network; wherein the UE is to include into the report information indicating at least one of:
a type I MIMO feedback, e.g., corresponding to an antenna port or beam selection;
a type II MIMO feedback, e.g., single layer
at least one layer comprising the first connectivity option and the second connectivity option provided by a single TRP, and/or
at least one layer comprising the first connectivity option and the second connectivity option provided jointly by the first TRP and the second TRP
a type II MIMO, e.g., rank 2 or at least two layers
each layer coming from one TRP, e.g., a first TRP providing for an associated first connectivity option and an associated second connectivity option; and/or
each layer of at least two layers resulting from a connectivity of a first TRP and a connectivity of a second TRP
parameters referring to signals received from different TRPs such as amplitude, phase and/or timing (absolute or difference values) capability to support multi-TRP or single-TRP operation
signalling a preference to switch from single-TRP to multi-TRP or vice versa

8. The user equipment, UE, of claim 1, wherein the UE is adapted to report to the wireless communication network, wherein the UE is to include into the report information indicating the connectivity information and information indicating a future position of the UE such as a direction information and/or a velocity information.

9. The user equipment, UE, of claim 1, wherein the UE is adapted to transmit, to the wireless communication network a capability signal indicating at least one of:
that the UE capable is capable to receive and decode the first signal received from the transmission/reception point, TRP, and the second signal received from the second TRP;
that the UE is capable of decoding multiple Master Information Blocks, MIBs, and/or system information blocks, SIBs, of multiple cells and/or TRPs;
the number of spatial layers that a UE is capable of supporting in uplink and/or downlink when connected to one or more non-collaborative or collaborative TRPs;
the number of TRPs that may serve the UE at the same time;
the number of TRP sets that may serve the UE at the same time;
a list of TRPs identified by the UE to be suitable for communication;
a list of TRP sets identified by the UE to be suitable for communication; and
a capability to measure a channel between at least one TRP and the UE and/or to measure channels between at least one collaborative set of TRPs and the UE.

10. The user equipment, UE, of claim 9, wherein the UE is adapted to receive information indicating preselected TRPs, e.g., by a Assistance Information Message, AIM, and/or via Sidelink, SL, and to generate the list of TRPs from the preselected TRPs.

11. The user equipment, UE, of claim 9, wherein the UE is adapted to indicate one or more suitable TRPs using an index of spatial resources used by the one or more TRPs.

12. The user equipment, UE, of claim 1, wherein the UE is to receive information, e.g., by decoding a Master Information Blocks, MIB, or a system information block, SIBs, indicating how many TRPs are using a specific cell-ID, reference signals, RS, or other specific identifiers associated with the joint resources e.g. jointly used REs and/or RSs.

13. The user equipment, UE, of claim 1, wherein the UE is to receive and decode an information block such as a master information block, MIB or system information block, SIB, comprising an identifier indicating a combination or collaboration of TRPs and/or a combination or collaboration of beams coming from different TRPs.

14. The user equipment, UE, of claim 1, wherein the UE is to receive and decode a signal indicating an operation mode of a set of operation modes implemented by the wireless communication network, the set of operation modes related to different types of use of the same resources with different TRPs.

15. The user equipment, UE, of claim 1, wherein the UE is configured to:
measure a quality parameter such as reference signal received power, RSRP, for a plurality of beams of at least two TRPs;
select a subset of the plurality of beams according to a selection criteria to obtain a selected subset; and
to report, to the wireless communication network, the selected subset as suitable candidates for providing the first signal and the second signal.

16. The user equipment, UE, of claim 1, wherein the UE is to access information of the wireless communication network indicating CSI reports together with an associated position and to use the CSI report and the position for a prediction of a future channel state.

17. The user equipment, UE, of claim 1, wherein the UE is to measure wireless channels based on reference signals, RS, associated to different base stations, sectors, beams and/or collaboration sets thereof and to provide a report to the wireless communication network indicating a result of the measuring.

18. The user equipment, UE, of claim 17, wherein the user equipment, UE, is to individually measure wireless channels.

19. The user equipment, UE, of claim 18, wherein the user equipment, UE, is to individually report about the wireless channels.

20. The user equipment, UE, according to claim 1, wherein the connectivity information comprises spatial domain related information not limited to at least one of:
one or more antennas of the TRP,
beamformers, wherein the beamformers can be analogue beamformers, digital beamformers or combinations thereof, aka hybrid beamformers
a transmit antenna port of the TRP,
a receive antenna port of the UE
a physical or logical antenna port, wherein
the individual antenna ports are associated with a single TRP or multiple TRPs
the individual antenna ports are associated with a single antenna panel or multiple antenna panels
an antenna panel,
panel numbers,
an antenna location,
an antenna radiation direction,
a quasi colocation, QCL, information,
a preferred matrix indicator,PMI,
a sorted or unsorted list of:
preferred beams, antenna ports in selection or combination
beams, antenna ports to be avoided in combination
combination of preferred beams and beams to be avoided in when selected individually, in sequence or in simultaneous combination
a set of beams, antenna ports and associated PMI, e.g., comprising codebook or port selection entries, phase and/or amplitude information for linear combinations of a selected subset of beams, antenna ports
a mode of transmission or reception to be maintained in single TRP or multi-TRP mode
a mode of transmission or reception to be changed from single-TRP to multi-TRP mode or from multi-TRP to single-TRP mode
a mode of transmission or reception to be changed from a first multi-TRP mode to a second multi-TRP mode or from a second multi-TRP to a first multi-TRP mode
the mode of single or multi-TRP operation can be signalled by a multiplicity of joint or pairs of DL/UL TCI states, wherein these states can be configured and activated

21. A wireless communication network comprising:
a device, according to claim 1;
a set of transmission/reception points, TRPs, including the first TRP and the second TRP, each TRP adapted to provide a signal in the wireless communication network to collaboratively transmit signals to the UE;
wherein the wireless communication network is configured for controlling the first TRP and the second TRP.
